(19) United States
(12) Patent Application Publication
(10) Pub. No.: US 2008/0183798 A1
(43) Pub. Date: Jul. 31, 2008

(54) DATA SYNCHRONIZATION METHOD BETWEEN A PLURALITY OF INFORMATION APPARATUS, INFORMATION PROCESSING APPARATUS FOR EXECUTING THE METHOD, AND PROGRAM FOR EXECUTING THE METHOD

(75) Inventor: Akihiro Sekine, Tokyo (JP)

Correspondence Address: DICKSTEIN SHAPIRO LLP, 1177 AVENUE OF THE AMERICAS (6TH AVENUE), NEW YORK, NY, 10036-2714, US

(73) Assignee: NEC CORPORATION, Tokyo (JP)

(21) Appl. No.: 12/057,308

(22) Filed: Mar. 27, 2008

Related U.S. Application Data
(63) Continuation of application No. 10/612,973, filed on Jul. 7, 2003, now abandoned.

(30) Foreign Application Priority Data
Jul. 8, 2002 (JP) 2002-199253

(51) Int. Cl. G06F 15/16

(52) U.S. Cl. 709/201

(57) ABSTRACT

A data synchronization method is disclosed by which a data synchronization process is performed automatically between a plurality of information apparatus. A record which forms data possessed by each information apparatus includes a data item representative of deletion information of the record and another data item. Time stamp information is fetched for each of the data items. A first one of the information apparatus transmits self data thereof including the time stamp information to a second one of the information apparatus which is a destination of data synchronization. Upon reception of the data transmitted from the first information apparatus, the second information apparatus compares the time stamp information for each of the data items included in the record of an updating object between the received data and the self data thereof and fetches the newest data to update the self data thereof.

### CROSS REFERENCE TO RELATED APPLICATION

This application is a continuation application of U.S. patent application Ser. No. 10/612,973, filed on Jul. 7, 2003, which claims priority to Japanese Patent Application No. 2002-199253, filed on Jul. 8, 2002, the contents of each are hereby incorporated by reference herein.

### BACKGROUND OF THE INVENTION

1. Field of the Invention

The present invention relates to a synchronization method for data stored in a plurality of information apparatus such as portable telephone sets, PHS (Personal Handyphone System) terminals, subscriber telephone sets, PDAs (Personal Digital Assistants) and personal computers, and more particularly to a data synchronization method which can automatically perform synchronization of data registered in a plurality of information apparatus.

2. Description of the Related Art

In recent years in which information apparatus have exhibited remarkable development, a user often utilizes a plurality of information apparatus such as a portable telephone set, a PHS terminal, a subscriber terminal, a PDA and a personal computer simultaneously. Where a plurality of information apparatus are utilized simultaneously in this manner, data of, for example, an address directory and a telephone directory are often used commonly among the information apparatus.

In such ubiquitous utilization of information apparatus, it is cumbersome to register the same data separately into the individual apparatus. Therefore, software has been developed for establishing data synchronism between two different information apparatus in such a manner that, for example, telephone directory data registered in a portable telephone set are synchronized with data of a personal computer. Further, a PDA can synchronize PIM (Personal Information Manager) information beginning with telephone directory data with a personal computer through a cradle.

However, in order to establish data synchronism using software developed in the past or through a cradle, it is necessary for a user to designate each of object apparatus as a destination of synchronization and perform data registration into the apparatus. Therefore, there is a problem in that the procedure for synchronization is very cumbersome and requires much time. Since various information apparatus such as portable telephone sets, PHS terminals, subscriber telephone sets, PDAs and personal computers can be seen everywhere, if a user who possesses a plurality of information apparatus intends to register data registered in one of the information apparatus similarly into the other information apparatus, then a data registration (transfer) operation must be performed every time. Thus, as the number of possessed information apparatus increases, the problem of the labor and the time for synchronization becomes more serious.

It is to be noted that, if one of information apparatus is designated as a master apparatus such that it performs centralized management of data and copies the data into the other information apparatus, then a data registration operation into the individual information apparatus can be simplified. This method, however, has a problem in that synchronization of data cannot be performed automatically. In particular, when it is intended to synchronize data having been registered into a personal computer or a subscriber telephone set at home and data having been registered into a portable telephone set, a PHS terminal or a PDA outside at a place where the user is with each other, the latest information cannot be managed generally by data copying from the master data. This is because, in such a case that the telephone number of the opposite party is fetched from an originating person information notification, it itself is impossible to select and designate one of a plurality of information apparatus as a master apparatus.

In this manner, in order to perform data management in a similar manner between or among a plurality of information apparatus, it is strongly demanded to automatically synchronize data registered in the individual apparatus between or among them to manage the latest information.

Various proposals have been offered for a method for synchronizing data between a plurality of information apparatus. For example, Japanese Patent Laid-Open No. 282745/1991 discloses a data synchronization method wherein, if a file is updated on a server computer, then the file is distributed to a client side computer to update the file of the client side computer.

With the data synchronization method just described, however, a synchronization process of a file can be performed only in one direction from the server to the client. Further, synchronization only in a unit of a file is permitted. Therefore, if the same file is updated by a plurality of clients, then the files of the clients cannot be synchronized with each other.

In addition to the document mentioned above, U.S. Pat. Nos. 5,684,990, 5,666,553, 5,943,676, 6,044,381, 6,141,664, 6,212,529, 6,223,187, 6,304,881 and 6,330,568 disclose related data synchronization methods.

### SUMMARY OF THE INVENTION

It is an object of the present invention to provide a data synchronization method which allows a bidirectional synchronization process between a plurality of information apparatus and allows synchronization also in a unit of a record or a cell in a file, and an information processing apparatus which implements the data synchronization method as well as a program for implementing processing of the data synchronization method.

In order to attain the object described above, according to an aspect of the present invention, there is provided a data synchronization method between a plurality of information apparatus for performing synchronization of data stored in the information apparatus, a record which forms data retained by each of the information apparatus including one or more data items, comprising a step, executed by each of the information apparatus when self data thereof is updated, of fetching time stamp information which indicates updating date and time for each of the data items, a step, executed by a first one of the information apparatus, of transmitting the self data thereof including the time stamp information of each of the data items to a second one of the information apparatus which is a destination of data synchronization, and a step, executed by the second information apparatus upon reception of the data transmitted from the first information apparatus, of comparing, regarding a data item which is an object of updating, the time stamp information of the self data thereof and the time stamp information transmitted from the first information apparatus with each other and fetching the newest time stamp information to update the self data thereof.

With the data synchronization method, time stamp information is fetched for each data item of a data record, and upon data synchronization between two information apparatus, the newest time stamp information is fetched regarding a data item of an object of synchronization to perform a synchronization process. Since data only of an item for which synchronization is required can be synchronized between the two information apparatus based on a result of the comparison of the time stamp information, the time required for the synchronization is shortened.

Preferably, the data synchronization method further comprises a step, executed by the second information apparatus, of transmitting the data including the updated time stamp information of each of the data items to the first information apparatus, and a step, executed by the first information apparatus, of comparing, regarding the data item which is an object of updating, the time stamp information of the self data thereof and the time stamp information transmitted from the second information apparatus with each other and fetching the newest time stamp information to update the self data thereof. With the data synchronization method, data synchronization can be performed between the two information apparatus by data exchange performed between them.

According to another aspect of the present invention, there is provided a data synchronization method between a plurality of information apparatus for performing synchronization of data stored in the information apparatus, a record which forms data retained by each of the information apparatus including a first data item which indicates deletion information of the record and one or more second data items other than the first data item, comprising a step, executed by each of the information apparatus when self data is updated, of fetching first time stamp information regarding the first data item and fetching, regarding each of the second data items, second time stamp information which indicates updating date and time for each of the second data items, a step, executed by a first one of the information apparatus, of transmitting the self data thereof including the first and second time stamp information to a second one of the information apparatus, and a step, executed by the second information apparatus upon reception of the data transmitted from the first information apparatus, of performing comparison, regarding the first and second data items included in a record of an updating object, between deletion information of the records, between both of the first time stamp information, between the first time stamp information and the second time stamp information, or between both of the second time stamp information and fetching the newest data to update the self data thereof.

With the data synchronization method, when necessary, deletion information of the records, the time stamp information of the records, the time stamp information of the record and the time stamp information of the data items, or the time stamp information of the data items can be compared with each other to perform data synchronization. Thus, data synchronization management can be performed in a unit of a record and besides in a unit of a data item. Consequently, data synchronization can be performed efficiently.

Preferably, the data synchronization method further comprises a step, executed by the second information apparatus upon reception of the data transmission from the first information apparatus, of transmitting the updated data to the first information apparatus, and a step, executed by the first information apparatus upon reception of the data transmission from the second information apparatus, of performing comparison, regarding the first and second data items included in the record of the updating object, between both of the deletion information of the records, between both of the first time stamp information, between the first time stamp information and the second time stamp information, or between both of the second time stamp information with each other and fetching the newest data to update the self data thereof. With the data synchronization method, data synchronization management can be performed in a unit of a record and besides in a unit of a data item by data exchange performed between the two information apparatus.

In both of the data synchronization methods described above, the data may be formed from a plurality of data tables which are related to each other. This allows easy synchronization of complicated data.

The record which forms the data may include data which indicates an attribute of the record and a data synchronization process regarding the record may be performed in accordance with the attribute. For example, each record may have an attribute of whether or not it may make an object of a synchronization process, and data synchronization may not be performed for a record which has an attribute that it does not make an object of a synchronization process. This can decrease the time required for data processing.

The data synchronization methods may be configured such that the information apparatus are divided into arbitrary groups each of which defines a range within which data exchange is to be performed, and each of the information apparatus includes, regarding all information apparatus which belong to a group to which the information apparatus itself belongs, group management data for managing a relationship regarding to which group each of the information apparatus belongs and selects, based on the group management data, an opposite information apparatus with which the information apparatus itself is to perform the synchronization process. Where group management of the information apparatus among which data exchange should be performed is performed to specify those information apparatus which make an object of a synchronization process in this manner, data synchronization can be performed efficiently.

In this instance, preferably the data synchronization method further comprises a step, executed by each of the information apparatus, of fetching time stamp information which indicates updating date and time of each record of the group management data, a step, executed by the first information apparatus, of transmitting the group management data including the time stamp information to the second information apparatus which is a destination of data synchronization, and a step, executed by the second information apparatus upon reception of the data transmission from the first information apparatus, of comparing the time stamp information of the self group management data thereof and the time stamp information of the group management data transmitted from the first information apparatus with each other and fetching the newest group management data to update the self group management data thereof. More preferably, the data synchronization method further comprises a step, executed by the second information apparatus upon reception of the transmission of the group management data, of transmitting the group management data thereof including the time stamp information updated thereby to the first information apparatus, and a step, executed by the first information apparatus upon reception of the data transmission from the second information apparatus, of comparing, regarding the group management data, the self time stamp information thereof and the time stamp information transmitted from the second information apparatus with each other and fetching the newest group management data information to update the self group management data thereof. Where data exchange is performed between the two information apparatus in this manner, data synchronization management can be performed by both of the information apparatus. It is to be noted that data exchange among more than two information apparatus is performed by performing data exchange between two information apparatus repetitively with the object of the data exchange changed.

Each of the information apparatus may include information apparatus management data for managing access information to an opposite information apparatus with which the information apparatus is to perform the data synchronization, and access, based on the information apparatus management data, the opposite information apparatus with which the information apparatus is to perform the synchronization process. Where the access destination with which data synchronization should be performed is managed in this manner, even if the user does not specify the destination of data synchronization, data synchronization can be performed automatically.

The data synchronization methods may be configured such that a record which forms the information apparatus management data includes time stamp information which indicates updating date and time of the record, and it further comprises a step, executed by the first information apparatus, of transmitting the information apparatus management data including the time stamp information to the second information apparatus which is the data synchronization destination, and a step, executed by the second information apparatus upon reception the data transmission from the first information apparatus, of comparing the time stamp information of the self information apparatus management data thereof and the time stamp information of the information apparatus management data transmitted from the first information apparatus with each other and fetching the newest information apparatus management data to update the self group management data thereof. The configuration just described can achieve data synchronization also of information apparatus management data.

In this instance, preferably the data synchronization method further comprises a step, executed by the second information apparatus upon reception of the transmission of the information apparatus management data, of transmitting the information management data thereof including the time stamp information updated thereby to the first information apparatus, and a step, executed by the first information apparatus upon reception of the data transmission, of comparing, regarding the information apparatus management data, the self time stamp information thereof and the time stamp information transmitted from the second information apparatus with each other and fetching the newest information apparatus management data to update the self information apparatus management data thereof. With the configuration just described, data synchronization of information apparatus management data can be performed by both of the two information apparatus. Data synchronization among more than two information apparatus is performed by performing data synchronization between two information apparatus repetitively with the object of the data synchronization changed.

Each of the information apparatus may possess data which indicates last synchronization date and time of each of the information apparatus which serves as a source of data transmission and perform data updating only when the time stamp information is newer than the last synchronization date and time of the information apparatus which is the source of the data transmission. With the configuration just described, since data prior to the last synchronization date and time is not subject to a synchronization process, the synchronization processing speed can be raised.

The data synchronization methods may be configured such that the data possessed by each of the information apparatus includes information which indicates an information apparatus of an origin of data for each record or each data item and does not perform the synchronization process regarding the record or data item when the information apparatus of the origin of the data is same as the information apparatus which is a destination of data synchronization. With the configuration just described, when data synchronization is performed among three or more information apparatus, since such data synchronization is performed by hearsay, the time required for the data synchronization process is shortened.

Preferably, in all of the information apparatus, or in all of those of the information apparatus which belong to a group in which the data synchronization process is performed, garbage collection is performed after data synchronization is performed for information that a record of a processing object is deleted in order to dispose of unnecessary data one by one.

The data synchronization process may be performed automatically in accordance with a predetermined time schedule. This can achieve automatic data synchronization between a plurality of information apparatus without imposing any labor on the user at all.

Each of the information apparatus may be selected from among apparatus including a portable telephone set, a personal computer, a PDA, a PHS terminal, a subscriber telephone set or a slave machine of a subscriber telephone set. Meanwhile, as a communication method between the information apparatus, a portable telephone network, a PHS telephone network, a cradle, the Internet, a subscriber telephone network, communication between a master machine and a slave machine of a subscriber telephone set, communication between slave machines of a subscriber telephone set or radio communication may be used.

In summary, with the data synchronization methods described above, a data synchronization process between a plurality of information processing apparatus can be automatically performed efficiently. Further, where a time schedule for a synchronization process is set in advance, since data synchronization is automatically performed at each predetermined timing without imposing any labor on the user at all, each of the information apparatus can normally possess the newest data. Furthermore, where group management of the information apparatus is performed, a data synchronization process can be performed further rapidly.

According to a further aspect of the present invention, there is provided an information processing apparatus for use with an information processing system for performing data exchange between a plurality of information apparatus, comprising data storage means for storing data of the self information apparatus, data reception means for receiving data from an opposite information apparatus, data comparison means for comparing the data stored in the data storage means and the data received by the data reception means, data updating means for updating the data of the self information apparatus based on a result of the data comparison by the data comparison means, time management means for managing data updating time of the day in the data updating means, and data transmission means for transmitting the data possessed by the self information apparatus to the opposite information apparatus.

According to a still further aspect of the present invention, there is provided an information processing apparatus for use with an information processing system for performing data exchange between a plurality of information apparatus, the plurality of information apparatus being divided into groups of apparatus within which the apparatus perform data exchange with each other, each of the information apparatus possessing group management data for managing a group belonging destination regarding all of those of the information apparatus which belong to a group to which the self information apparatus belongs, comprising data storage means for storing data of the self information apparatus, data reception means for receiving data from an opposite information apparatus, data comparison means for comparing the data stored in the data storage means and the data received by the data reception means with each other, data updating means for updating the data of the self information apparatus based on a result of the data comparison by the data comparison means, time management means for managing data updating time of the day in the data updating means, data transmission means for transmitting the data possessed by the self information apparatus to the opposite information apparatus, group management data storage means for storing group management data of the self information apparatus, group management data comparison means for comparing the data stored in the group management data storage means and group management data of the opposite information apparatus transmitted through the data reception means with each other, group management data updating means for updating the group management data of the self information apparatus based on a result of the comparison by the group management data comparison means, and time management means for managing data updating time of the day in the group management data updating means.

The above and other objects, features and advantages of the present invention will become apparent from the following description and the appended claims, taken in conjunction with the accompanying drawings in which like parts or elements are denoted by like reference characters.

### BRIEF DESCRIPTION OF THE DRAWINGS

FIG. 1 is a diagrammatic view showing a configuration of a plurality of information apparatus which can execute a data synchronization method according to the present invention;

FIG. 2 is a block diagram showing a configuration of an information processing apparatus used in the data synchronization method of the present invention;

FIG. 3 is a view illustrating a data format stored in a first one of the information apparatus before data synchronization is performed;

FIG. 4 is a similar view but illustrating a data format stored in a second one of the information apparatus before the data synchronization is performed;

FIG. 5 is a similar view but illustrating a data format stored in the first information apparatus after the data synchronization is performed;

FIG. 6 is a similar view but illustrating a data format stored in the second information apparatus after the data synchronization is performed;

FIGS. 7 to 11 are flow charts illustrating different data comparison procedures in the data synchronization method;

FIGS. 12 to 14 are views illustrating different examples of the data format used in the data synchronization method;

FIGS. 15 and 16 are views illustrating different configurations of sub data of the data format illustrated in FIG. 14;

FIG. 17 is a view illustrating a different example of the data format used in the data synchronization method;

FIG. 18 is a schematic view illustrating a manner of grouping used in a second data synchronization method according to the present invention;

FIG. 19 is a view illustrating group management data where the grouping illustrated in FIG. 18 is employed;

FIG. 20 is a view illustrating a data format which can be used suitably where the grouping illustrated in FIG. 18 is employed;

FIG. 21 is a block diagram showing an information processing apparatus which can be suitably used in the data synchronization method which involves the grouping illustrated in FIG. 18;

FIG. 22 is a diagrammatic view illustrating another manner of grouping used in the second data synchronization method;

FIG. 23 is a view illustrating group management data in a first information apparatus where the grouping illustrated in FIG. 22 is employed;

FIG. 24 is a view illustrating group management data in a second information apparatus where the grouping illustrated in FIG. 22 is employed;

FIG. 25 is a view illustrating information apparatus management data in the first information apparatus where the grouping illustrated in FIG. 22 is employed;

FIG. 26 is a view illustrating information apparatus management data in the second information apparatus where the grouping illustrated in FIG. 22 is employed;

FIGS. 27 and 28 are views illustrating different data formats with which the grouping illustrated in FIG. 22 can be suitably used;

FIG. 29 is a diagram illustrating a sequence of a data synchronization process in accordance with the present invention; and

FIGS. 30, 31 and 32 are views illustrating different data formats which can be used suitably in the data synchronization method of the present invention.

### DESCRIPTION OF THE PREFERRED EMBODIMENTS

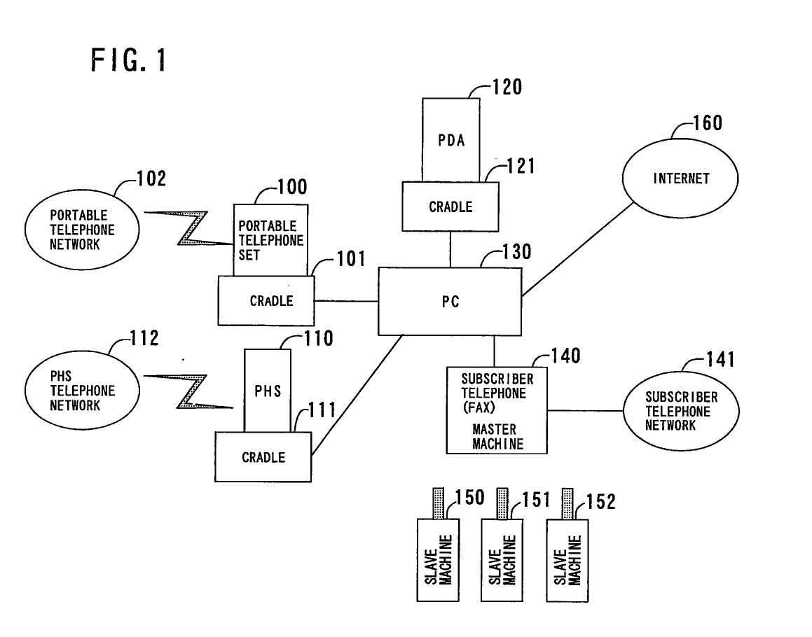

Referring first to FIG. 1, there is shown a configuration of an example of an information apparatus system to which a data synchronization method according to the present invention can be applied. The information apparatus system shown includes a plurality of information apparatus including a portable telephone set 100, a PHS terminal 110, a PDA 120, a personal computer 130, a subscriber telephone set 140, and slave machines 150, 151, 152, . . . of the subscriber telephone set 140. Each of the information apparatus main may communicate by any method with another one of the information processing apparatus which belong to the system so that data synchronization is performed automatically among the information apparatus.

Particularly, the portable telephone set 100 exchanges data with another portable telephone set through a portable telephone network 102, with the personal computer 130 through a cradle 101 and with some other information apparatus using some other communication means. The PHS terminal 110 exchanges data with another PHS through a PHS telephone network 112, with the personal computer 130 through a cradle 111 or with some other information apparatus using some other communication means. The PDA 120 exchanges data with the personal computer 130 through a cradle 121. The personal computer 130 exchanges data with another information apparatus through the Internet 160 or by RS-232C, USB, IEEE 1394 or radio communication.

The subscriber telephone set (slave machine) 140 exchanges data with a slave machine by master-slave machine communication, with another subscriber telephone set through a subscriber telephone network 141 or with another information apparatus by RS-232C, USB, IEEE 1394 or radio communication. Each of the slave machines 150, 151, 152, . . . exchanges data with the master machine by master-slave machine communication, with another slave machine by slave-slave machine communication, or with another information apparatus by some other communication means.

A connection scheme for exchanging data between different information apparatus may be selected from among a telephone network, the Internet (analog circuit, ISDN (Integrated Services Digital Network), an ADSL (Asymmetric Digital Subscriber Line), an optical fiber or the like), RS-232C, USB (Universal Serial Bus), IEEE 1394, LAN (Ethernet (registered trade mark) or the like) or radio communication (IrDA (Infrared Data Association), Bluetooth or the like), and so forth. However, the connection scheme is not limited particularly in carrying out the present invention.

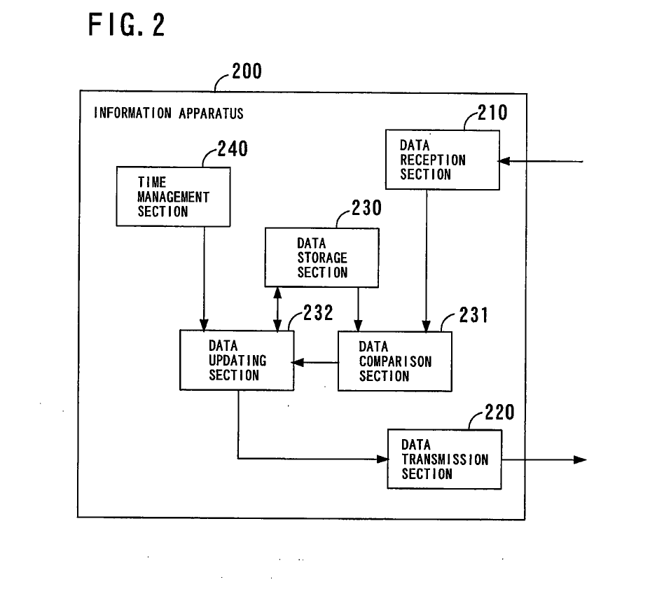

FIG. 2 shows a configuration of an information processing apparatus according to the present invention which may be incorporated in any of the information apparatus described above.

Referring to FIG. 2, the information processing apparatus or information apparatus 200 shown includes a data reception section 210 for receiving data from another information processing apparatus, a data transmission section 220 for transmitting data to another information apparatus, a data storage section 230 for storing data of the information processing apparatus 200 itself, a data comparison section 231 for comparing the data stored in the data storage section 230 and data received by the data reception section 210, a data updating section 232 for updating the data stored in the data storage section 230 based on a result of the comparison by the data comparison section 231, and a time management section 240 for managing the updating date and time upon data updating by the data updating section 232.

The information processing apparatus 200 operates in the following manner. In particular, the data reception section 210 receives and sends external data sent thereto from another information processing apparatus to the data comparison section 231. The data comparison section 231 compares the external data with the self data stored in the data storage section 230 and sends a result of the comparison to the data updating section 232. The data updating section 232 updates the internal data based on the comparison result received from the data comparison section 231. As hereinafter described in detail, each of the external data received from the different information apparatus and the internal data stored in the data storage section 230 includes the last updating date and time, and also the updating date and time is updated upon updating of the data. Since the information processing apparatus 200 includes the time management section 240, it can acquire accurate time information from the time management section 240 in order to update the updating date and time. It is to be noted that, not only upon data synchronization but also when the information processing apparatus 200 newly registers or updates the data of the data storage section 230, the data updating section 232 acquires accurate time information from the time management section 240, updates the updating date and time together with the updating data and stores them into the data storage section 230.

The time management section 240 may perform such time adjustment individually in the information processing apparatus 200 using, for example, a radio controlled clock or may acquire accurate time information using the UTP (Network Time Protocol) or the like. Here, the method for the time adjustment is not limited particularly, but any method may be employed only if accurate time information can be acquired.

In the following, a particular synchronization procedure is described. Prior to the description, however, several terms are defined as follows:

(1) A field in which a certain record is present is defined as “cell”.
(2) A cell whose key is common between or among data of two or more information apparatus and whose record stores data of the same kind between or among the information apparatus is defined as “same cell”. In other words, a “same cell” signifies a cell which makes an object of comparison of data to discriminate whether the data is newer or older and signifies a cell in which new data is to be reflected on old data.
(3) Where the information apparatus X includes a same cell, it is defined as IX.
(4) The updating date and time of a cell of the information apparatus X is defined as “update(X)”.
(5) The deletion date and time of a certain record of the information apparatus X is defined as “delete(X)”.
(6) Where a certain record of the information apparatus X is not deleted, this is defined as “update(X)>delete(X)”. In other words, this signifies that the update(X) is newer than the delete(X).
(7) Where a certain record of the information apparatus X is deleted, this is defined as “update(X)<delete(X)”. In other words, this signifies that the update(X) is older than the delete(X).
(8) Where the update(X) is newer than the update(Y), this is defined as “update(X)>update(Y)”.
(9) Where the update(X) is equal to the update(Y), this is defined as “update(X)=update(Y)”.
(10) Where the update(X) is older than the update(Y), this is defined as “update(X)<update(Y)”.
(11) Where the update(X) is newer than the delete(Y), this is defined as “update(X)>update(Y)”.
(12) Where the update(X) is equal to the delete(Y), this is defined as “update(X)=update(Y)”.
(13) Where the update(X) is older than the delete(Y), this is defined as “update(X)<update(Y)”.
(14) Where the data of the same cell of the information apparatus Y is copied into the data of the same cell of the information apparatus X, this is defined as “data(X) © data(Y)”.
(15) Where the updating date and time of the same cell of the information apparatus Y is copied into the updating date and time of the same cell of the information apparatus X, this is defined as “update(X) © update(Y)”.
(16) Where the deletion date and time of the same cell of the information apparatus Y is copied into the deletion date and time of the same cell of the information apparatus X, this is defined as “delete(X) © delete(Y)”.
(17) Where the data priority of the information apparatus X is higher than the data priority of the information apparatus Y, this is defined as “priority(X)>priority(Y)”.
(18) Where the data priority of the information apparatus X is lower than the data priority of the information apparatus Y, this is defined as “priority(X)<priority(Y)”.

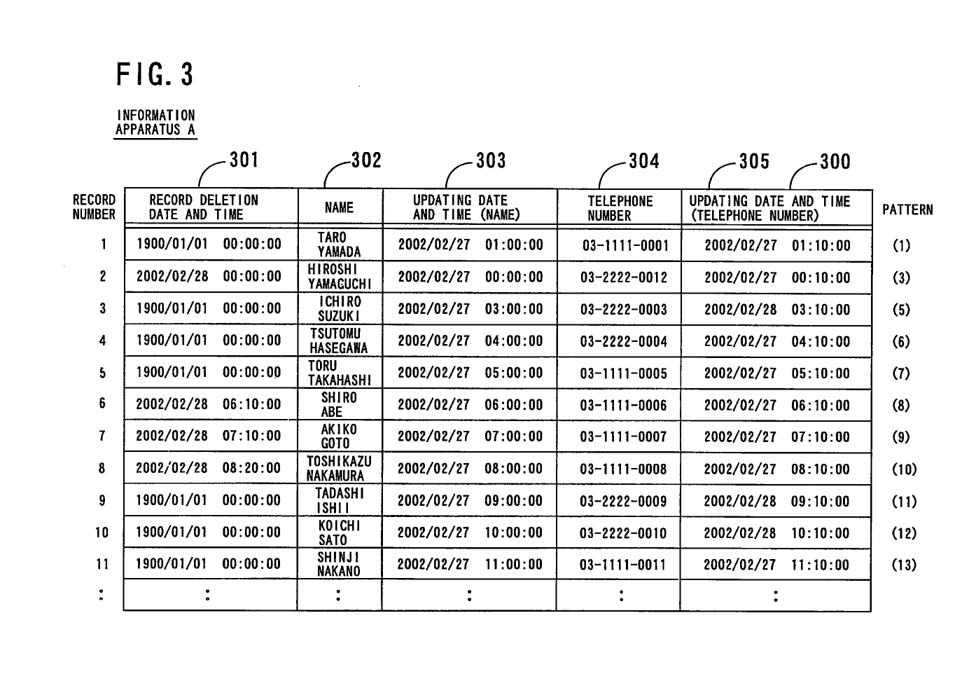

Now, a data synchronization method to which the present invention is applied is described with reference to FIGS. 3 to 6 taking operation thereof when data synchronization is performed between two information apparatus A and B as an example. Data whose synchronization is to be performed is stored in the form of a telephone directory table in each of the information apparatus.

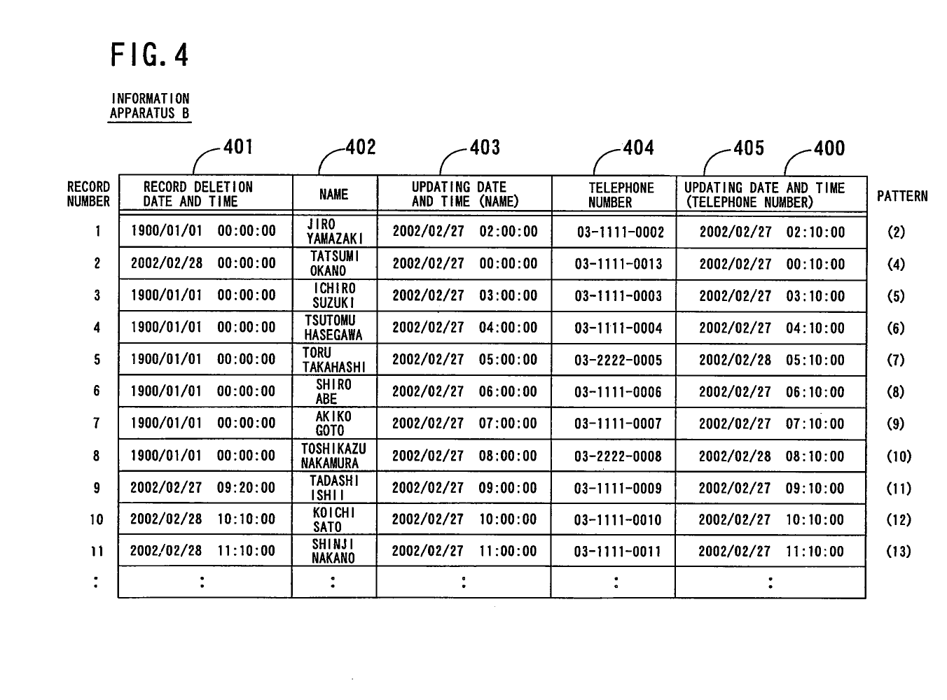

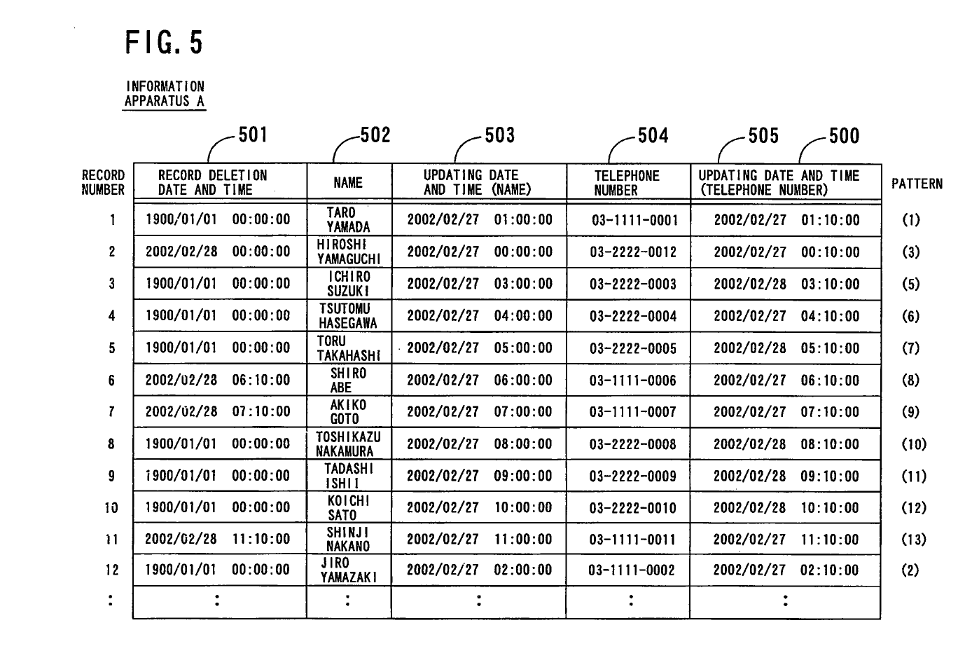

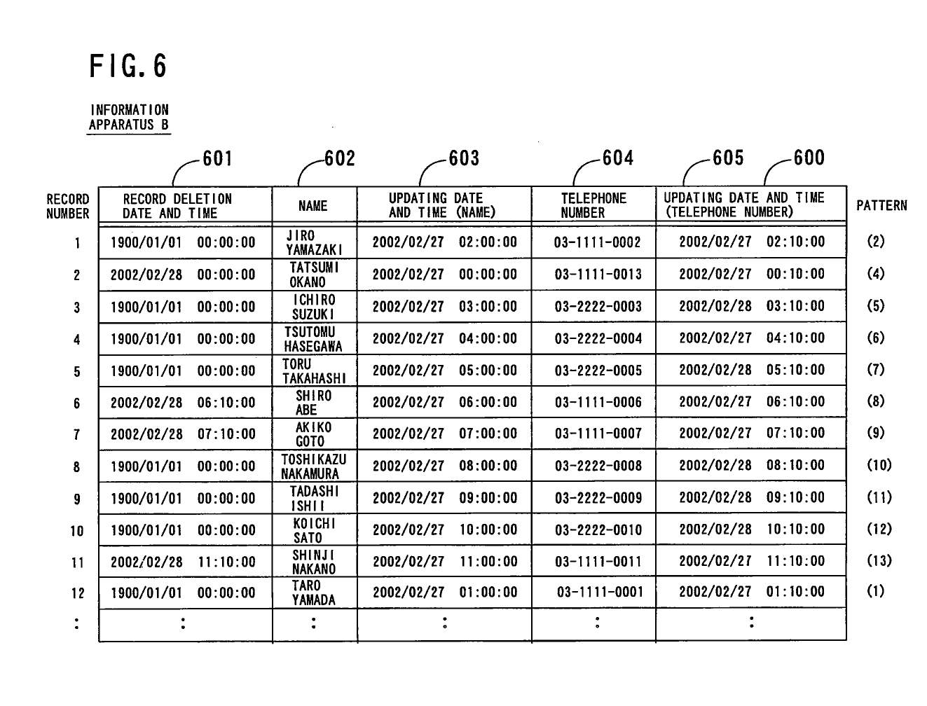

FIG. 3 illustrates the telephone directory table possessed by the information apparatus A before the data synchronization and FIG. 4 illustrates the telephone directory table possessed by the information apparatus B before the data synchronization. Meanwhile, FIG. 5 illustrates the telephone directory table of the information apparatus A after the data synchronization and FIG. 6 illustrates the telephone directory table of the information apparatus B after the data synchronization.

Referring to FIGS. 3 to 6, each of the telephone directory tables 300 to 600 includes five data items including a record deletion date and time 301 to 601, a name 302 to 602, an updating date and time (name) 303 to 603, a telephone number 304 to 604 and an updating date and time (telephone number) 305 to 605.

Description is given below taking the telephone directory table 300 as an example. The record deletion date and time 301 indicates the date and time of deletion (for example, 2002/02/27) if the pertaining record is deleted, but indicates particular date and time if the record is not deleted. The particular date and time should be non-realistic date and time, and in the examples shown in FIGS. 3 to 6, for example, 1900/01/01 00:00:00 is used as the particular date and time. In other words, if the record deletion date and time 301=1900/01/01 00:00:00, then this signifies that the pertaining record is not deleted.

The updating date and time (name) 303 indicates the date and time on which the name 302 of the pertaining record is updated while the updating date and time (telephone number) 305 indicates the date and time on which the telephone number 304 of the pertaining record is updated. It is to be noted that, although the record number is not actually registered in the table, it is applied for facilitation of citation in the following description. Also the data tables illustrated in FIGS. 4, 5 and 6 have a similar configuration.

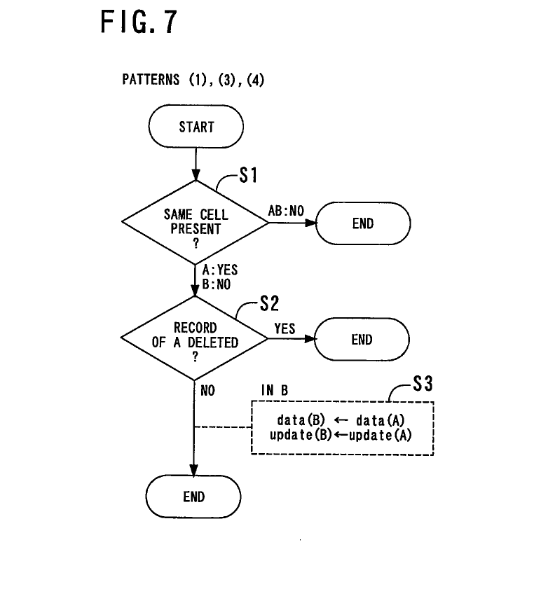

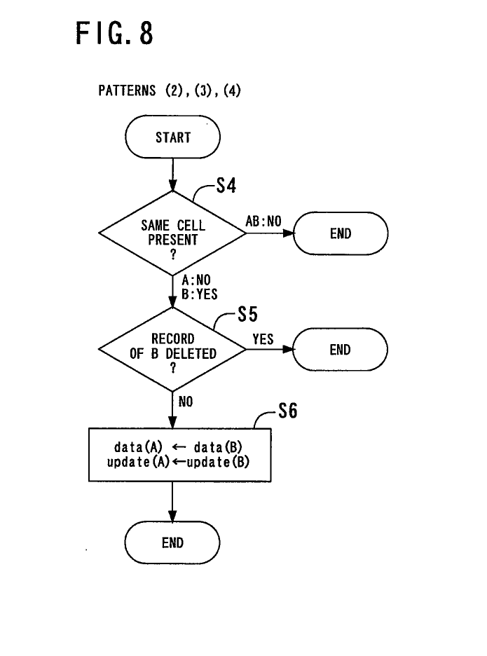

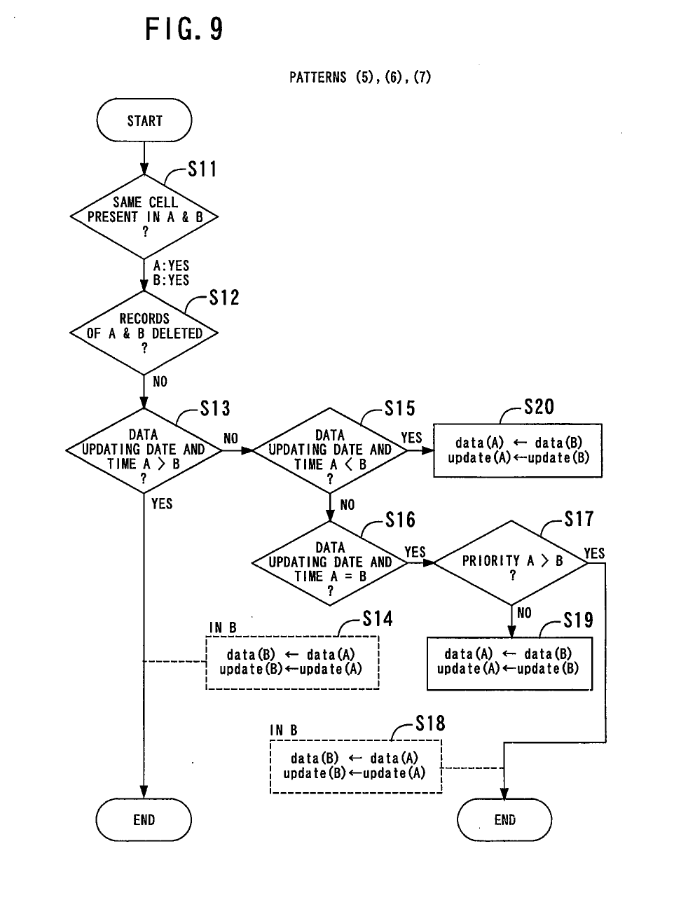

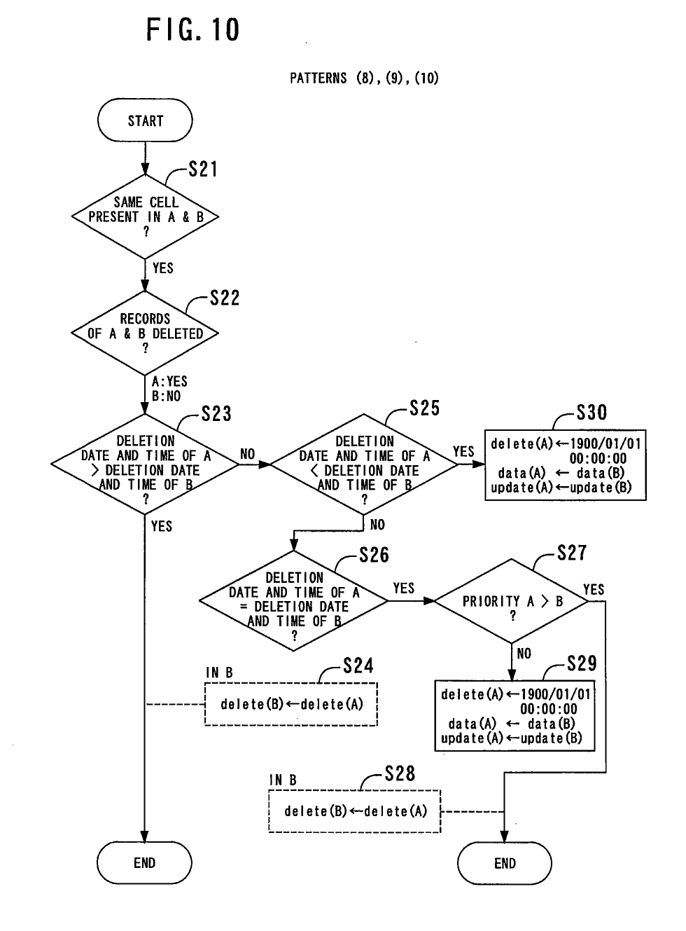

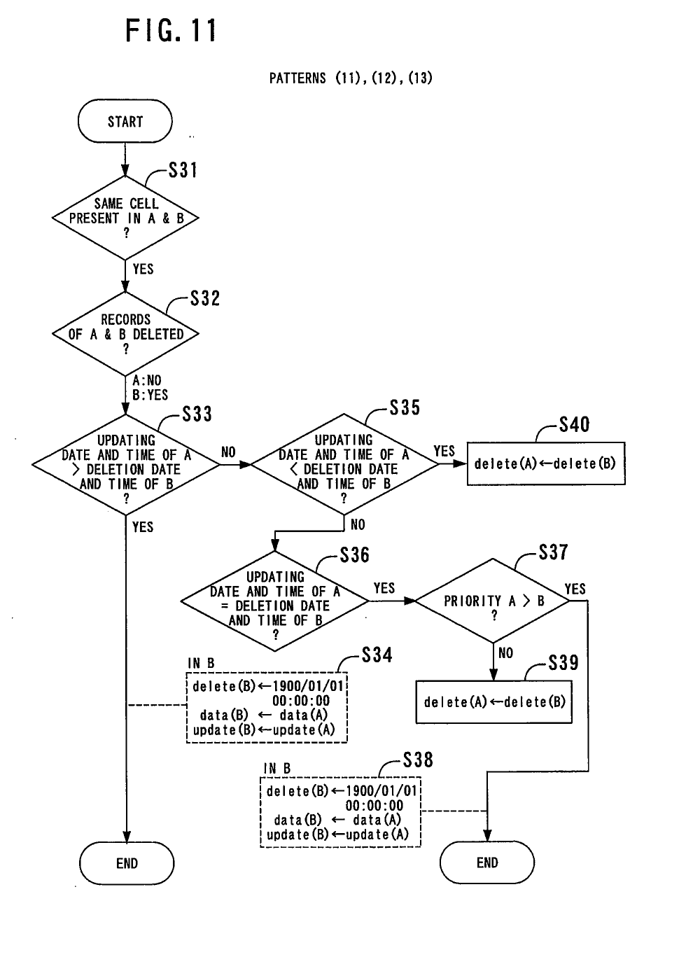

FIGS. 7 to 11 illustrate a comparison process procedure performed by the data comparison section 231 when a data synchronization process is performed between the two information apparatus A and B. It is to be noted that FIGS. 7 to 11 illustrate a data comparison process procedure executed by the information apparatus A when the information apparatus A receives data from the information apparatus B.

The data synchronization process between the information apparatus A and the information apparatus B can be performed in any of the following 13 different patterns.

It is to be noted that the data synchronization between the information apparatus A and the information apparatus B signifies that, where the information apparatus A possesses data newer than that of the information apparatus B, the data of the information apparatus A is reflected on the information apparatus B, but where the information apparatus B possesses newer data than that of the information apparatus A, the data of the information apparatus B is reflected on the information apparatus A. In other words, the data synchronization process performed between the information apparatus A and the information apparatus B is a symmetrical process with respect to the information apparatus A and the information apparatus B. It is to be noted that, in FIGS. 7 to 11, processes executed by the information apparatus B when data exchange is performed between the information apparatus A and B are indicated by broken lines for precaution's sake.

(1) (Î(A) and not Î(B) and (delete(A)=1900/01/01 00:00:00)

The pattern (1) is a process where the same cell is present in the information apparatus A but is not present in the information apparatus B (step S1: A=YES, B=NO) and the record of the information apparatus A is not deleted (step S2: NO). In this instance, the information apparatus A does not perform any particular process. When data exchange is to be performed, the information apparatus B copies data of the same cell of the information apparatus A onto the same cell of the information apparatus B and the updating date and time of the same cell of the information apparatus A is copied onto the updating date and time of the same cell of the information apparatus B (step S3).

(2) (not Î(A) and Î(B) and (delete(B)=1900/01/01 00:00:00)

The pattern (2) is a process where the same cell is not present in the information apparatus A but is present in the information apparatus B (step S4: A=YES, B=NO) and the record of the information apparatus B is not deleted (step S5: NO). In this instance, the information apparatus A copies data of the same cell of the information apparatus B onto the same cell of the information apparatus A and the updating date and time of the same cell of the information apparatus B is copied onto the updating date and time of the same cell of the information apparatus A (step S6) to effect a synchronization process. The information apparatus B does not perform any particular process.

(3) (Î(A) and not Î(B) and (delete(A) ? 1900/01/01 00:00:00)
(4) (not Î(A) and Î(B) and (delete(B) ? 1900/01/01 00:00:00)

The pattern (3) is a process where the same cell is present in the information apparatus A but is not present in the information apparatus B (step S1: A=YES, B=NO) and the record of the information apparatus A is deleted (step S2: YES). The pattern (4) is a process where the same cell is not present in the information apparatus A but is present in the information apparatus B (step S4: A=YES, B=NO) and the record of the information apparatus B is deleted (step S5: YES). In this instance, neither of the information apparatus A and the information apparatus B performs any process.

(5) (Î(A) and Î(B)) and (delete(A)=1900/01/01 00:00:00) and (delete(B)=1900/01/01 00:00:00) and (update(A)>update(B))

The pattern (5) is a process where the same cell is present in both of the information apparatus A and the information apparatus B (step S11: YES) and the deletion date and time of the record is not deleted from any of the information apparatus A and B (step S12: NO) and the data updating date and time of the same cell of the information apparatus A is newer than that of the information apparatus B (step S13: YES).

In this instance, the information apparatus A does not perform any particular process. When data exchange is to be performed, the information apparatus B copies data of the same cell of the information apparatus A onto the data of the same cell of the information apparatus B and further copies the data updating date and time of the same cell of the information apparatus A onto the data updating date and time of the information apparatus B (step S14).

(6) (Î(A) and Î(B)) and (delete(A)=1900/01/01 00:00:00) and (delete(B)=1900/01/01 00:00:00) and (update(A)=update(B))

The pattern (6) is a process where the same cell is present in both of the information apparatus A and the information apparatus B (step S11: YES) and the deletion date and time of the record is not deleted from any of the information apparatus A and B (step S12: NO) and besides the data updating date and time of the same cell of the information apparatus A is same as that of the information apparatus B (step S13: NO, step S15: NO, step S16: YES).

In this instance, the priorities of the information apparatus A and B are further compared with each other (step S17). In particular, if the data priority of the information apparatus A is higher than that of the information apparatus B (step S17: YES) (priority(A)>priority(B)), then the information apparatus A does not perform any particular process. If data exchange has been performed, then the data of the same cell of the information apparatus A is copied onto the data of the same cell of the information apparatus B and the data updating date and time of the same cell of the information apparatus B is copied onto the data updating date and time of the information apparatus A (step S18).

On the other hand, if the data priority of the information apparatus A is lower than that of the information apparatus B (step S17: NO) (priority(A)<priority(B)), then the data of the same cell of the information apparatus B is copied onto the data of the same cell of the information apparatus A and the data updating date and time of the same cell of the information apparatus A is copied onto the data updating date and time of the information apparatus B (step S19). The information apparatus B does not perform any particular process.

(7) (Î(A) and Î(B)) and (delete(A)=1900/01/01 00:00:00) and (delete(B)=1900/01/01 00:00:00) and (update(A)<update(B))

The pattern (7) is a process where the same cell is present in both of the information apparatus A and the information apparatus B (step S11: YES) and the deletion date and time of the record is not deleted from any of the information apparatus A and B (step S12, NO) and besides the data updating date and time of the same cell of the information apparatus A is older than that of the information apparatus B (step S13: NO, step S15: YES).

In this instance, the information apparatus A copies the data of the same cell of the information apparatus B onto the data of the same cell of the information apparatus A and further copies the updating date and time of the same cell of the information apparatus B onto the deletion date and time of the information apparatus A (step S20). The information apparatus B does not perform any particular process.

(8) (Î(A) and Î(B)) and (delete(A) ? 1900/01/01 00:00:00) and (delete(B)=1900/01/01 00:00:00) and (delete(A)>update(B))

The pattern (8) is a process where the same cell is present in both of the information apparatus A and the information apparatus B (step S21, YES) and the deletion date and time of the record is deleted from the information apparatus A but is not deleted from the information apparatus B (step S22: A=YES, B=NO) and besides the data updating date and time of the same cell of the information apparatus A is newer than that of the information apparatus B (step S23: YES).

In this instance, the information apparatus A does not perform any particular process. When data exchange is to be performed, the information apparatus B copies the data of the same cell of the information apparatus A onto the deletion date and time of the same cell of the information apparatus B (step S24).

(9) (Î(A) and Î(B)) and (delete(A) ? 1900/01/01 00:00:00) and (delete(B)=1900/01/01 00:00:00) and (delete(A)=update(B))

The pattern (9) is a process where the same cell is present in both of the information apparatus A and the information apparatus B (step S21, YES) and the deletion date and time of the record is updated in the information apparatus A but is not deleted in the information apparatus B (step S22: A=YES, B=NO) and besides the data updating date and time of the same cell of the information apparatus A is same as that of the information apparatus B (step S23:, NO, step S24: NO, step S25: YES).

In this instance, the priorities of the information apparatus A and B are compared with each other for later processing (step S26). In particular, if the data priority of the information apparatus A is higher than that of the information apparatus B (step S26: YES) (priority(A)>priority(B)), then the information apparatus A does not perform any particular process. If data exchange is to be performed, then the deletion date and time of the same cell of the information apparatus A is copied onto the deletion date and time of the same cell of the information apparatus B (step S27).

On the other hand, if the data priority of the information apparatus A is lower than that of the information apparatus B (step S26: NO) (priority(A)<priority(B)), then the deletion date and time of the same cell of the information apparatus A is set to 1900/01/01 00:00:99 and the data of the information apparatus B is copied onto the data of the information apparatus A and besides the updating date and time of the same cell of the information apparatus B is copied onto the updating date and time of the same cell of the information apparatus A (step S28). The information apparatus B does not perform any particular process.

(10) (Î(A) and Î(B)) and (delete(A) ? 1900/01/01 00:00:00) and (delete(B)=1900/01/01 00:00:00) and (delete(A)<update(B))

The pattern (10) is a process where the same cell is present in both of the information apparatus A and the information apparatus B (step S21: YES) and the deletion date and time of the record is updated in the information apparatus A but is not deleted from the information apparatus B (step S22: A=YES, B=NO) and besides the data updating date and time of the same cell of the information apparatus A is older than that of the information apparatus B (step S23: NO, step S24: YES).

In this instance, the information apparatus A sets the updating date and time of the same cell to “1900/01/01 00:00:00 and copies the data of the same cell of the information apparatus B onto the updating date and time of the same cell of the information apparatus A (step S29). If data exchange is performed, then the information apparatus B does not perform any particular process.

(11) (Î(A) and Î(B)) and (delete(A)=1900/01/01 00:00:00) and (delete(B) ? 1900/01/01 00:00:00) and (update(A)>delete(B))

The pattern (11) is a process where the same cell is present in both of the information apparatus A and the information apparatus B (step S31: YES) and the deletion date and time of the record is not deleted in the information apparatus A but the deletion date and time is deleted from the information apparatus B (step S32: A=YES, B=NO) and besides the data updating date and time of the same cell of the information apparatus A is newer than the deletion date and time of the same cell of the information apparatus B (step S33, YES).

In this instance, the information apparatus A does not perform any particular process. If data exchange is performed, then the information apparatus B sets the deletion date and time of the same cell to “1900/01/01 00:00:00 and copies the data of the same cell of the information apparatus A onto the data of the same cell of the information apparatus B and further copies the updating date and time of the information apparatus A onto the updating date and time of the same cell of the information apparatus B (step S34).

(12) (Î(A) and Î(B)) and (delete(A)=1900/01/01 00:00:00) and (delete(B) ? 1900/01/01 00:00:00) and (update(A)=delete(B))

The pattern (12) is a process where the same cell is present in both of the information apparatus A and the information apparatus B (step S31: YES) and the deletion date and time of the record is deleted from the information apparatus A but the deletion date and time of the record is updated in the information apparatus B (step S32: A=YES, B=NO) and besides the data updating date and time of the same cell of the information apparatus A is same as the deletion date and time of the same cell of the information apparatus B (step S33: NO, step S35: NO, step S36: YES).

In this instance, if the data priority of the information apparatus A is higher than that of the information apparatus B (step S37: YES) (priority(A)>priority(B)), then the information apparatus A does not perform any particular process. If data exchange is to be performed, then the deletion date and time of the same cell of the information apparatus B is set to “1900/01/01 00:00:00” and the data of the same cell of the information apparatus A is copied onto the data of the same cell of the information apparatus B and besides the data updating date and time of the data of the information apparatus A is copied onto the data updating date and time of the information apparatus B (step S38).

On the other hand, if the data priority of the information apparatus A is lower than that of the information apparatus B (step S37: NO) (priority(A)<priority(B)), then the data deletion date and time of the same cell of the information apparatus B is copied onto the data deletion date and time of the information apparatus A (step S39). The information apparatus B does not perform any particular process.

(13) (Î(A) and Î(B)) and (delete(A)=1900/01/01 00:00:00) and (delete(B) ? 1900/01/01 00:00:00) and (update(A)<delete(B))

The pattern (13) is a process where the same cell is present in both of the information apparatus A and the information apparatus B (step S31: YES) and the deletion date and time of the record is not deleted in the information apparatus A but the deletion date and time is updated in the information apparatus B (step S32: A=NO, B=YES) and besides the data updating date and time of the same cell of the information apparatus A is older than the deletion date and time of the same cell of the information apparatus B (step S33:, NO, step S35: YES).

In this instance, the information apparatus A copies the deletion date and time of the same cell of the information apparatus B onto the deletion date and time of the same cell of the information apparatus A (step S40). Meanwhile, the information apparatus B does not perform any particular process.

Thus, where the information apparatus A and B possess the telephone directory tables shown in FIGS. 3 and 4, if, in order to perform data exchange between the information apparatus A and B, the data priority of the information apparatus B is set higher than that of the information apparatus A first and the data comparison section 231 and the data updating section 232 compare received data with self data to update the data in accordance with the flow charts shown in FIGS. 7 to 11, then the telephone directory tables shown in FIGS. 3 and 4 change to the telephone directory tables shown in FIGS. 5 and 6, respectively. In other words, the deletion date and time and the data updating date and time of each data are updated in accordance with the patterns described above, and the thus updated data are exchanged between the pertaining information apparatus to effect data synchronization. The pattern numbers at the right end in each of FIGS. 3 to 6 individually correspond to the pattern numbers described above.

It is to be noted that data exchange need not necessarily be performed, but the system may be designed otherwise such that, for example, only data of a main computer apparatus are always updated to new data.

Also it is to be noted that the patterns described above include those patterns wherein the data updating date and time or the deletion date and time is equal between the pertaining information apparatus. However, it is estimated that, if the updating date and time or the deletion date and time is set using a very small unit such as, for example, millisecond, then such a case that the updating date and time or the deletion date and time is found equal little appears.

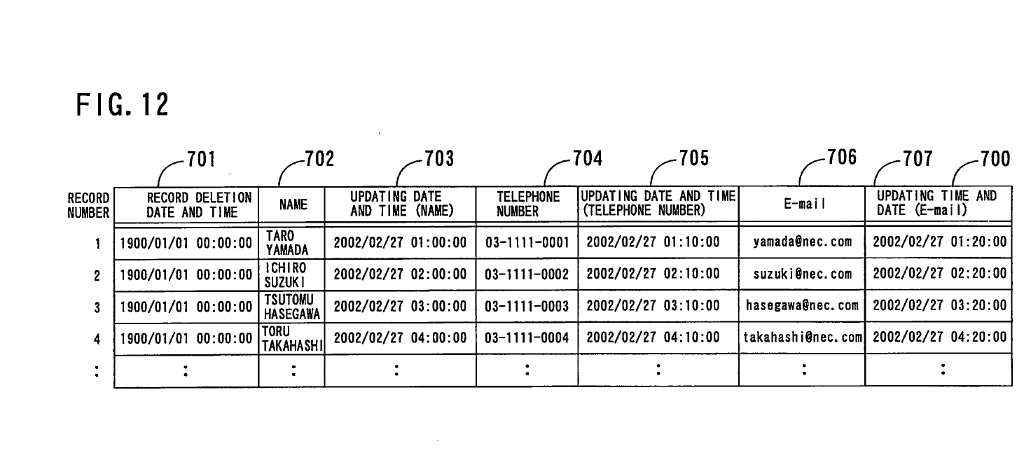

FIGS. 12 to 17 show examples of the telephone directory table which can be utilized suitably in the first embodiment of the present invention.

In the telephone directory table shown in FIG. 12, not only the name and a telephone number but also an e-mail address can be registered into each record. In particular, in the telephone directory table 700 shown, each record includes an E-mail 706 and an updating time and date (E-mail) 707 in addition to a record deletion date and time 701, a name 702, an updating date and time (name) 703, a telephone number 704 and an updating date and time (telephone number) 705. The number of data items included in each record may be any number in this manner. Also in this instance, if the comparison procedure is followed while the data updating date and time is possessed for each data item, then data synchronization can be achieved between different information apparatus.

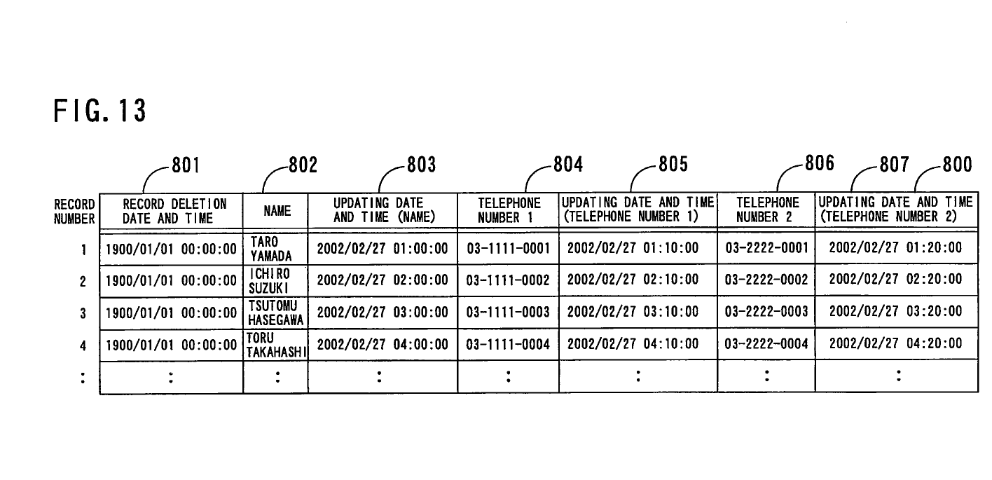

In the telephone directory table shown in FIG. 13, each record can include two telephone numbers. In particular, in the telephone directory table 800 shown, each record includes a telephone number 1 804, an updating time and date (telephone number 1) 805, a telephone number 2 806 and an updating date and time (telephone number 2) 807 in addition to a record deletion date and time 801, a name 802 and an updating date and time (name) 803. Where the updating date and time is possessed for each of the telephone numbers and the comparison procedure described above is followed, data synchronization can be achieved. It is to be noted that data synchronization can be achieved also with regard to more than two telephone numbers.

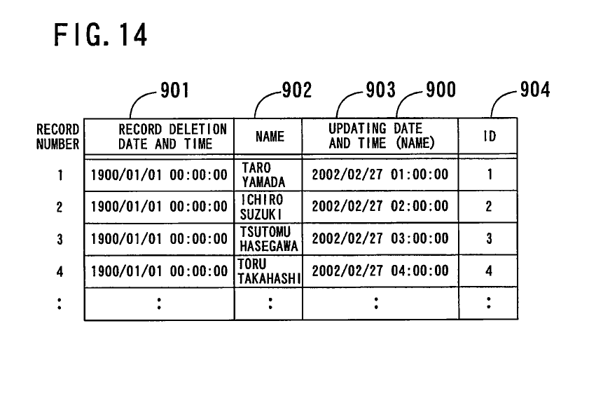

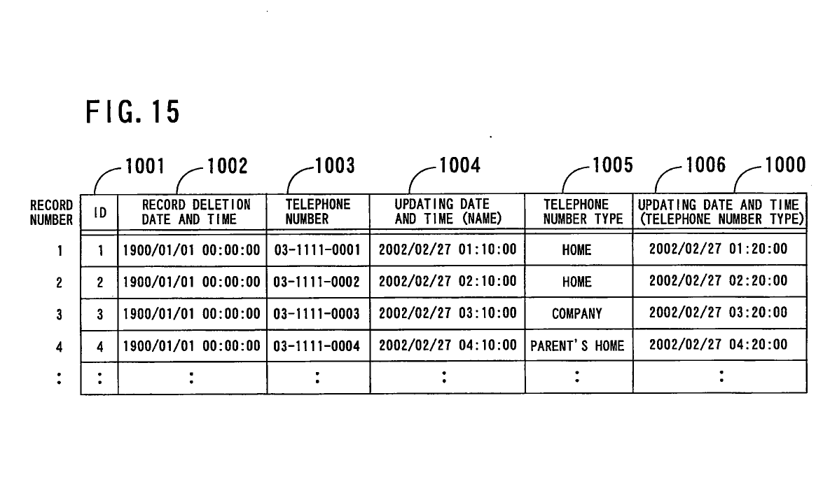

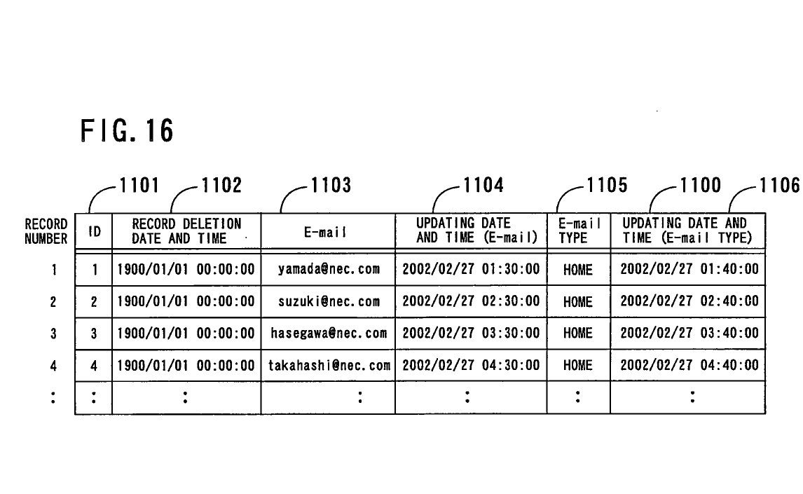

The telephone directory table shown in FIG. 14 is associated with sub tables shown in FIGS. 15 and 16 which are possessed by the data storage sections of the pertaining information apparatus. In the telephone directory table shown in FIG. 14, an ID in the sub tables of FIGS. 15 and 16 is registered in each record thereof for the association with the sub tables. In particular, in the telephone directory table 900 shown in FIG. 14, each record includes an ID 904 in addition to a record deletion date and time 901, a name 902 and an updating date and time (name) 903. Meanwhile, in the sub table 1000 shown in FIG. 15, each record includes an ID 1001, a record deletion date and time 1002, a telephone number 1003, an updating date and time (telephone number) 1004, a telephone number type 1005 and an updating date and time (telephone number type) 1006. In the sub table 1100 shown in FIG. 16, each record includes an ID 1101, a record deletion date and time 1102, an E-mail 1103, an updating date and time (E-mail) 1104, an E-mail type 1105 and an updating date and time (E-mail type) 1106. By the configuration just described, an arbitrary number of items such as a telephone number and an e-mail address can be registered in each record. Also here, data synchronization between the pertaining information apparatus can be performed by the comparison procedure described hereinabove.

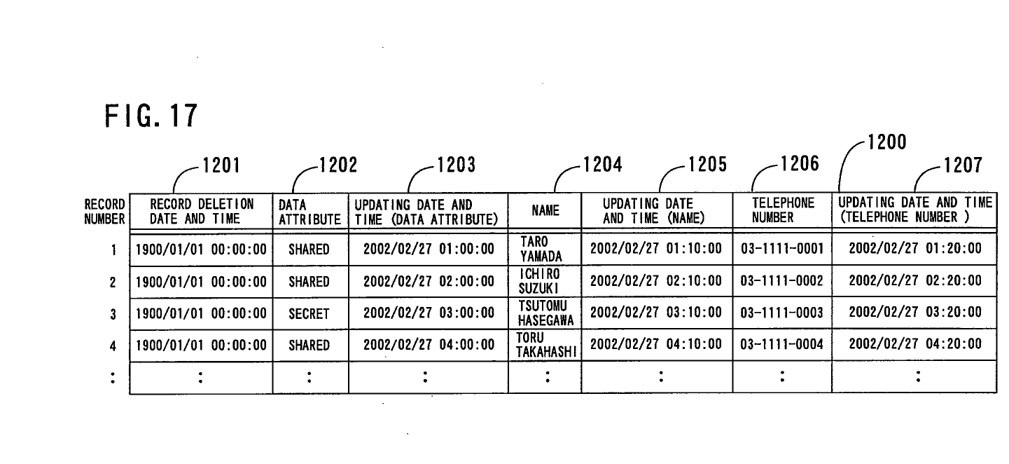

FIG. 17 shows a different telephone directory table which can be utilized suitably in the first embodiment of the present invention. Referring to FIG. 17, in the telephone directory table shown, each record includes a data attribute 1202 and an updating date and time (data attribute) 1203 in addition to a record deletion date and time 1201, a name 1204, an updating date and time (name) 1205, a telephone number 1206 and an updating date and time (telephone number) 1207. Consequently, if the data attribute 1202 is referred to, then it is possible to select whether the pertaining record should be handled as a shared record with another information apparatus or as a unique record unique to the information processing apparatus (that is, as a secret). Thus, for a record to be handled as a shared record, data synchronization is performed using the method described above. However, for a record to be handled as a unique record, data synchronization is not performed because it should not make an object of a data synchronization process.

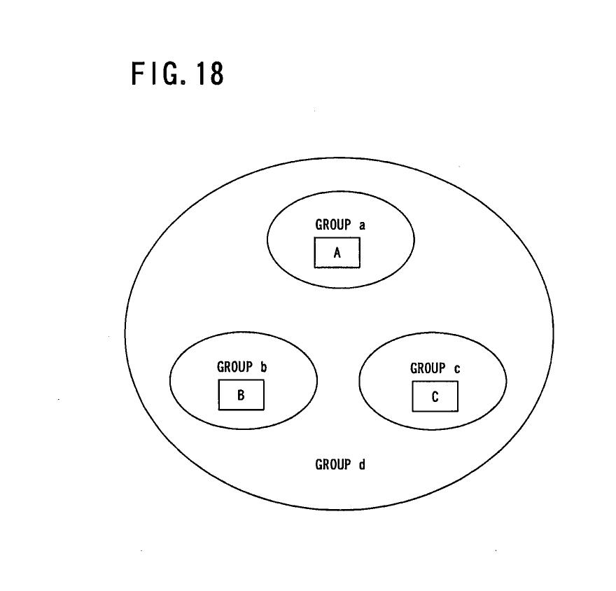

FIGS. 18 to 21 show a configuration of another information processing system and a data synchronization method to which the present invention is applied.

The data synchronization method of the present embodiment can be utilized suitably where data synchronization is performed among three or more information apparatus. In the data synchronization method described below, a plurality of information apparatus are divided into groups each of which includes those information apparatus among which data synchronization should be performed, and each of the information apparatus manages such group information to effect group synchronization when necessary.

FIG. 18 illustrates an example of division of a set of information apparatus into groups according to the second embodiment. Referring to FIG. 18, three information apparatus A, B and C form an information apparatus set which is divided into four groups including a group a to which only the information apparatus A belongs, another group b to which only the information apparatus B belongs, a further group c to which only the information apparatus C belongs, and a still further group d to which all of the information apparatus A, B and C belong. Each of the information apparatus A, B and C possesses a group management table for managing information apparatus information of the information apparatus of the groups to which the information apparatus A, B or C itself belongs and a data management table for managing real data such as telephone directory data.

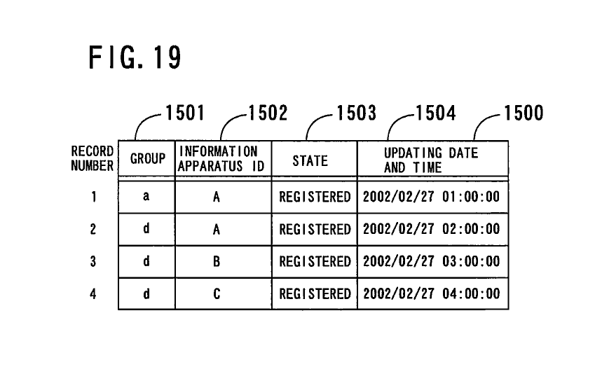

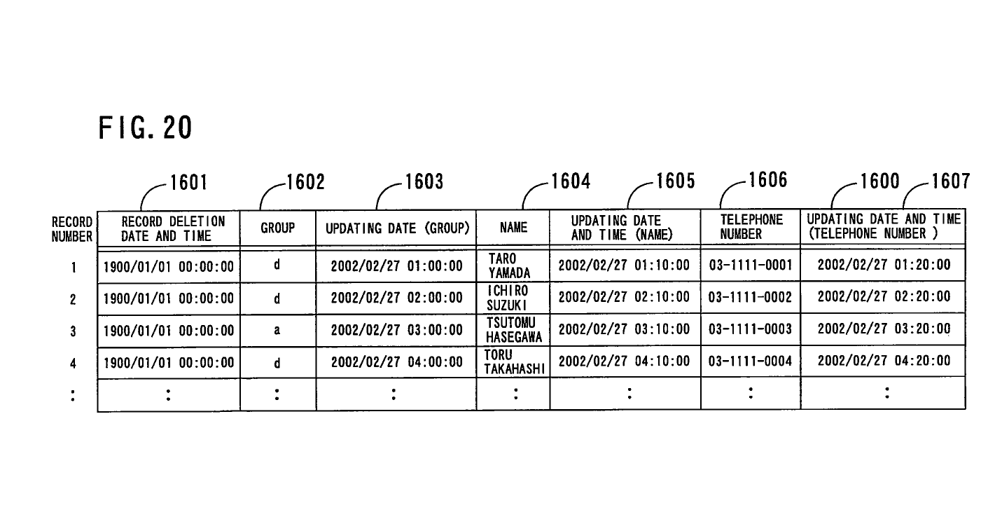

FIG. 19 shows a configuration of the group management table possessed by the information apparatus A, and FIG. 20 shows a configuration of the data management table (telephone directory data) possessed by the information apparatus A.

Referring first to FIG. 19, the group management table 1500 includes four data items including a group 1501, an information apparatus ID 1502, a registration state 1503 and an updating date and time 1504 and manages to which group any information apparatus belongs. The registration state 1503 assumes a value of registered or deleted and indicates whether the pertaining record is registered or deleted. The updating date and time 1504 indicates the date and time on which the pertaining record is registered or deleted.

Referring now to FIG. 20, each record in the telephone directory management table 1600 includes a group 1602 relating to a group to which each record belongs and an updating date (group) 1603 in addition to the data items of the telephone directory management table (FIG. 17) used in the first embodiment, that is, in addition to a record deletion date and time 1601, a name 1604, an updating date and time (name) 1605, a telephone number 1606 and an updating date and time (telephone number) 1607. In particular, data whose group indication is a is managed only by the information apparatus A, and accordingly, it is not synchronized with data of any other apparatus. Meanwhile, data whose group indication is d is synchronized among the information apparatus A, B and C which belong to the group d. This group management corresponds to the data attribute 1202 of the management table 1200 shown in FIG. 17. Thus, in the second embodiment, whether the pertaining data is shared data or secret data managed with the data attribute 1202 in the first embodiment is managed with the group 1602.

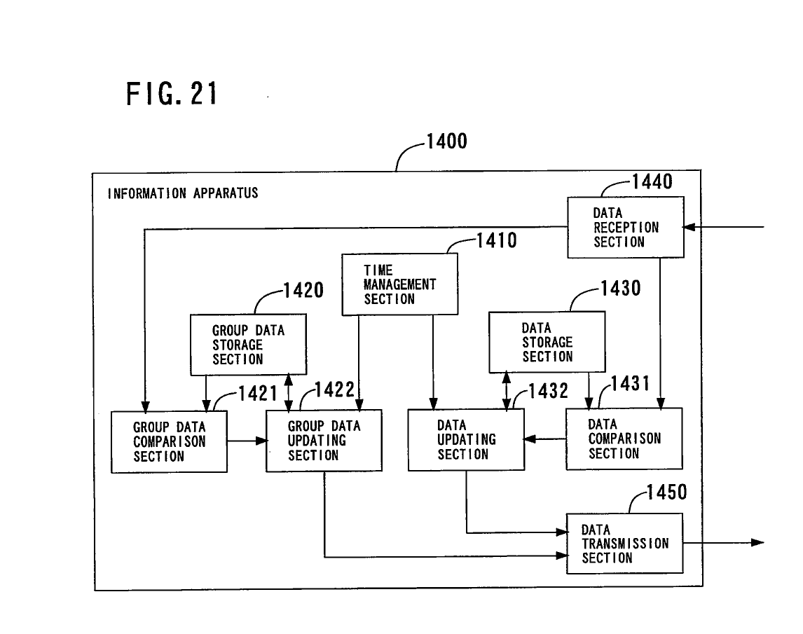

FIG. 21 shows a configuration of an information processing apparatus which can be used suitably where such group management as just described is involved. Referring to FIG. 21, the information processing apparatus is a modification to but is different from the information processing apparatus described hereinabove with reference to FIG. 2 in that it additionally includes components for updating a group management table. In particular, the information processing apparatus includes a group data storage section 1420, a group data comparison section 1421 and a group data updating section 1422 in addition to a time management section 1410, a data storage section 1430, a data comparison section 1431, a data updating section 1432, a data reception section 1440 and a data transmission section 1450. The group data storage section 1420 has the above-described group management data stored therein. The group data comparison section 1421 compares group management data of another information apparatus sent thereto from the data reception section 1440 with the data stored in the group data storage section 1420. The group data updating section 1422 updates the group management data based on a result of the comparison by the group data comparison section 1421 and transmits the updated group management data to the other information apparatus through the data transmission section 1450.

It is to be noted that, while the data management sections for group management and the data processing sections for data table management are provided separately in the information apparatus 1400 shown in FIG. 21, it is otherwise possible to use the configuration shown in FIG. 2 as it is such that both of the group data and the actual data table are handled by the data storage section 230, data comparison section 231, data updating section 232 and time management section 240.

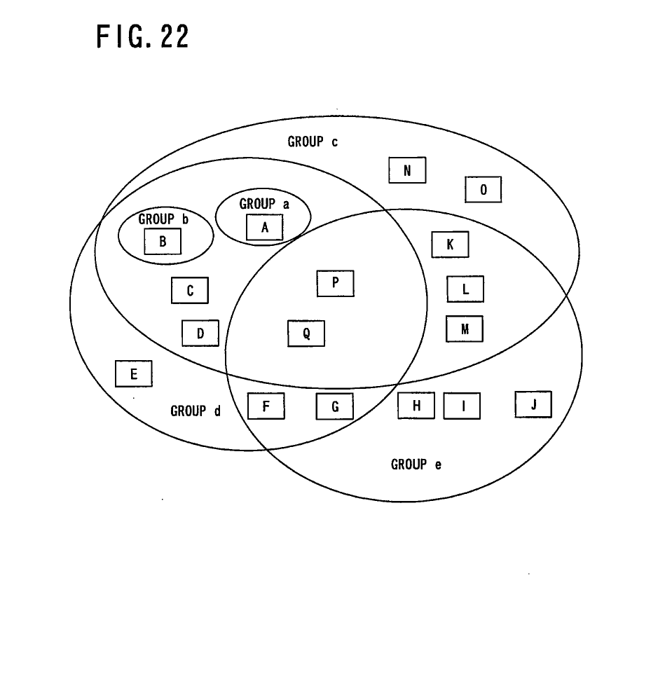

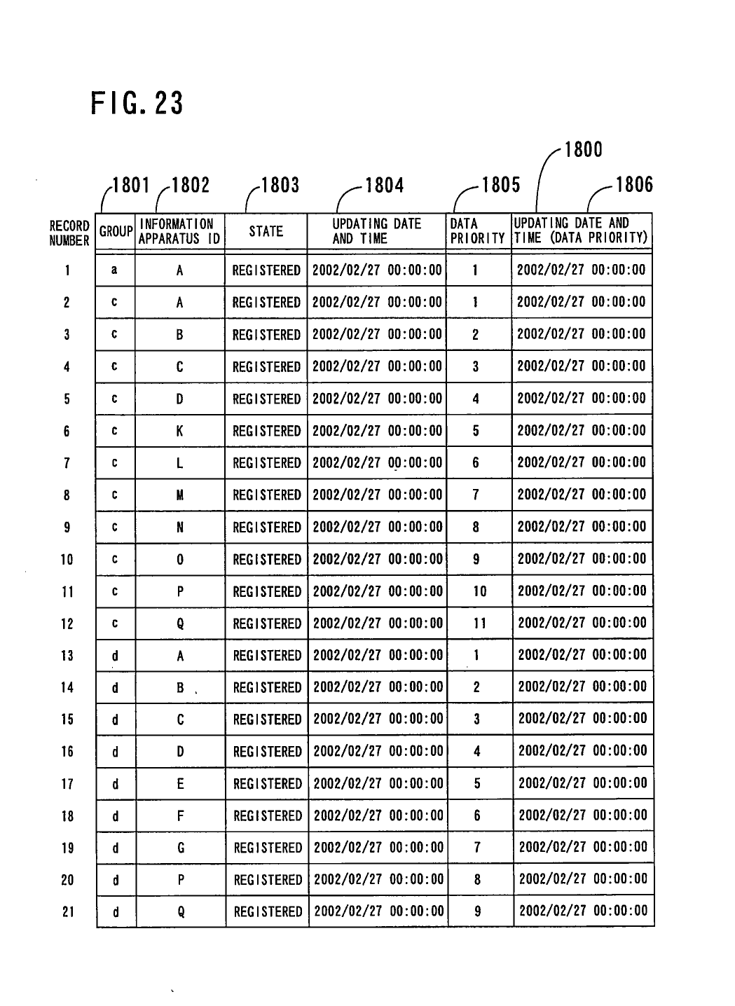

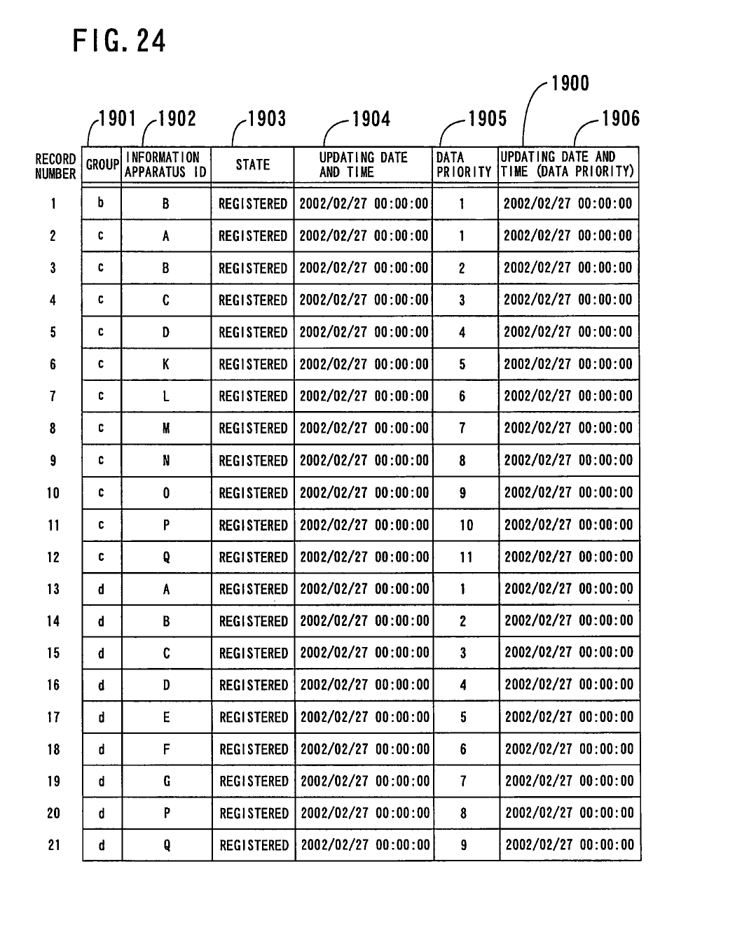

FIG. 22 shows another example of grouping of information apparatus. Referring to FIG. 22, each of information apparatus A to Q belongs to one of groups a to e. A configuration of the group management table of the information apparatus A shown in FIG. 22 is shown in FIG. 23, and a configuration of the group management table of the information apparatus B is shown in FIG. 24. In particular, each record in the group management table 1800 shown in FIG. 23 includes a group 1801, an information apparatus ID 1802, a state 1803, an updating date and time 1804, a data priority 1805 and an updating date and time (data priority) 1806. Meanwhile, each record in the group management table 1900 shown in FIG. 24 includes a group 1901, an information apparatus ID 1902, a state 1903, an updating date and time 1904, a data priority 1905 and an updating date and time (data priority) 1906.

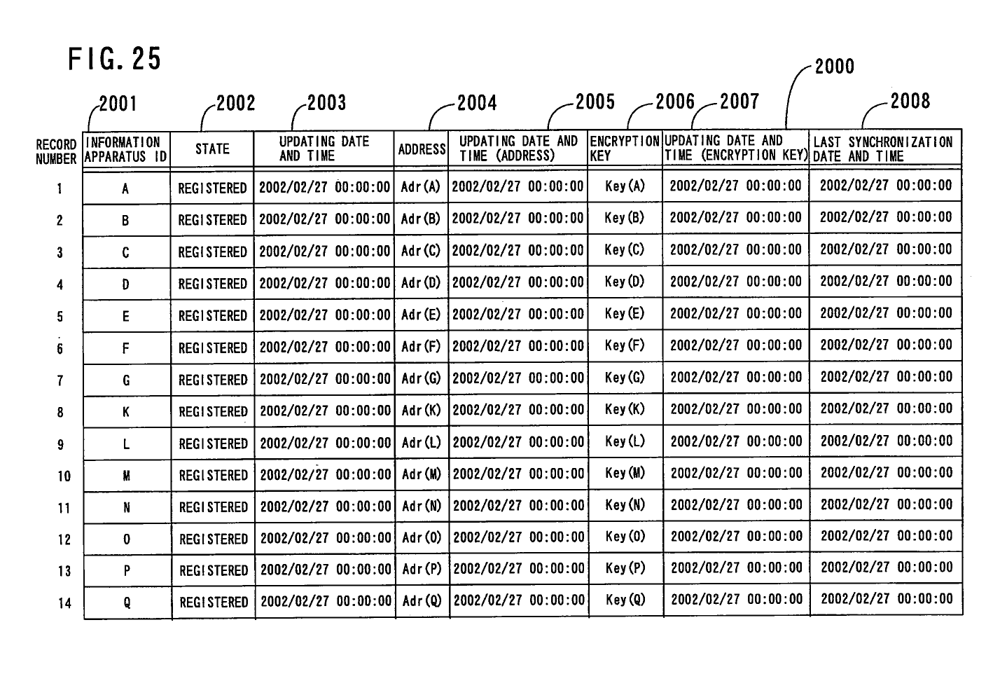

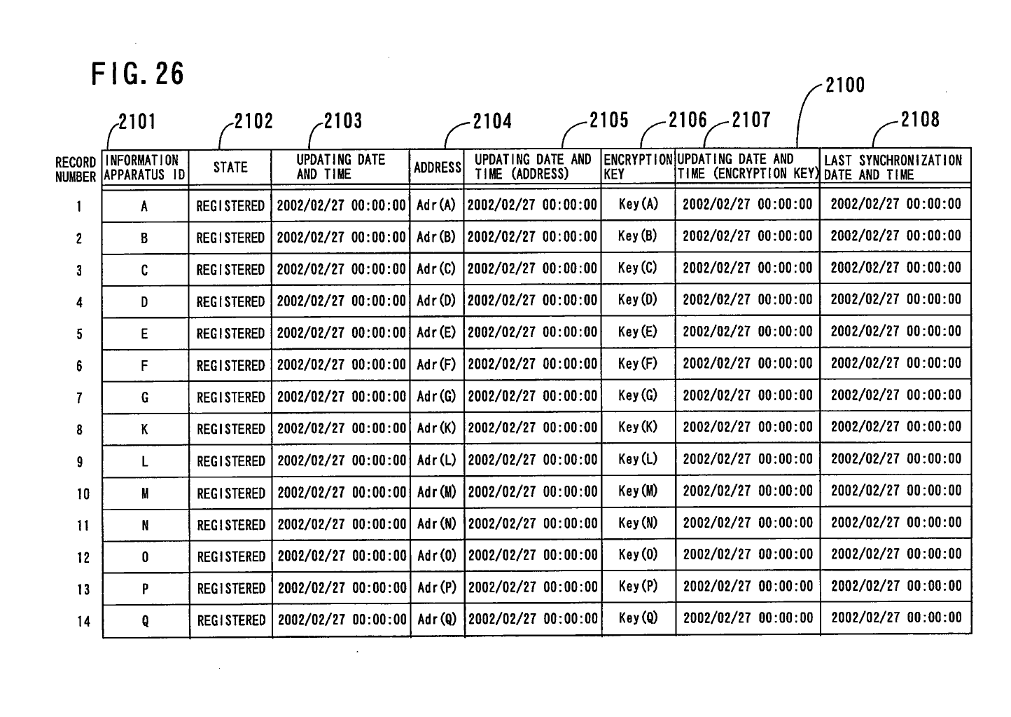

It is to be noted that, when a data synchronization process is performed, preferably data exchange is performed between information apparatus. In this instance, it is necessary for each of the information apparatus to retain address information of an opposite information apparatus with which it should perform data exchange. Further, where radio communication is used for data exchange between information apparatus, it is necessary for each of the information apparatus to retain an encryption key to be used for data exchange in order to maintain the secrecy of the data. In order to retain the necessary information, each of the information apparatus includes a respective information apparatus management table. FIGS. 25 and 26 show a configuration of the information apparatus management tables possessed by the information apparatus A and B where the information apparatus A to Q are grouped in such a manner as seen in FIG. 22.

Referring to FIGS. 25 and 26, each record of the information apparatus management table 2000 (2100) includes an information apparatus ID 2001 (2101), a registration state 2002 (2102), an updating date and time (record) 2003 (2103), an address 2004 (2104), an updating date and time (address) 2005 (2105), an encryption key 2006 (2106), an updating date and time (encryption key) 2007 (2107), and a last synchronization date and time 2008 (2108).

The information apparatus ID 2001 (2101) is an ID of the opposite information apparatus with which data synchronization should be performed (that is, data exchange should be performed). The registration state 2002 (2102) has one of two values of registered and deleted and indicates whether the pertaining record is in a registered state or in a deleted state. The updating date and time (record) 2003 (2103) indicates the date and time on which the record is registered or deleted. The address 2004 (2104) indicates an address of the opposite information apparatus with which data exchange should be performed. The updating date and time (address) 2005 (2105) indicates the date and time on which the address 2004 (2104) is updated. The encryption key 2006 (2106) is an encryption key of the opposite information apparatus with which data exchange should be performed. The updating date and time (encryption key) 2007 (2107) indicates the date and time on which the encryption key 2006 (2106) is updated. The last synchronization date and time 2008 (2108) indicates the date and time on which data synchronization was performed (data exchange was performed) last with the opposite information apparatus indicated by the pertaining record.

Here, each record includes the last synchronization date and time 2008 (2108), and the time required for a data synchronization process can be reduced in the following manner by use of the same. Description is given of data synchronization between the information apparatus A and B as an example. From FIG. 25, it can be seen that the date and time on which the information apparatus A and the information apparatus B performed data synchronization last is 2002/02/27 00:00:00 as seen from the last synchronization date and time 2008 of the record number=2. Consequently, it can be recognized that, since data by the last data updating date and time is reflected on any record where the updating date and time or deletion date and time of the data is prior to 2002/02/27 00:00:00, upon a data synchronization process between the information apparatus A and B, a synchronization process should be performed only for those data whose updating date and time or deletion date and time is later than 2002/02/27 00:00:00. Accordingly, if the data comparison section compares the updating date and time (or deletion date and time) of each data with the last synchronization date and time and the synchronization processes illustrated in FIGS. 7 to 11 are performed for those data whose updating date and time (or deletion date and time) is later than the last synchronization date and time, then the time required for the data synchronization process can be reduced.

It is to be noted that, as seen from FIGS. 25 and 26, the information apparatus management table retains not only information regarding an opposite information apparatus with which it is to exchange data but also information regarding the information apparatus itself. This is because it may become necessary to transmit information regarding the information apparatus itself to the opposite information apparatus when it performs data exchange. It is to be noted that the information apparatus management table stores information of all information apparatus which belong to the groups to which the information apparatus itself belongs.

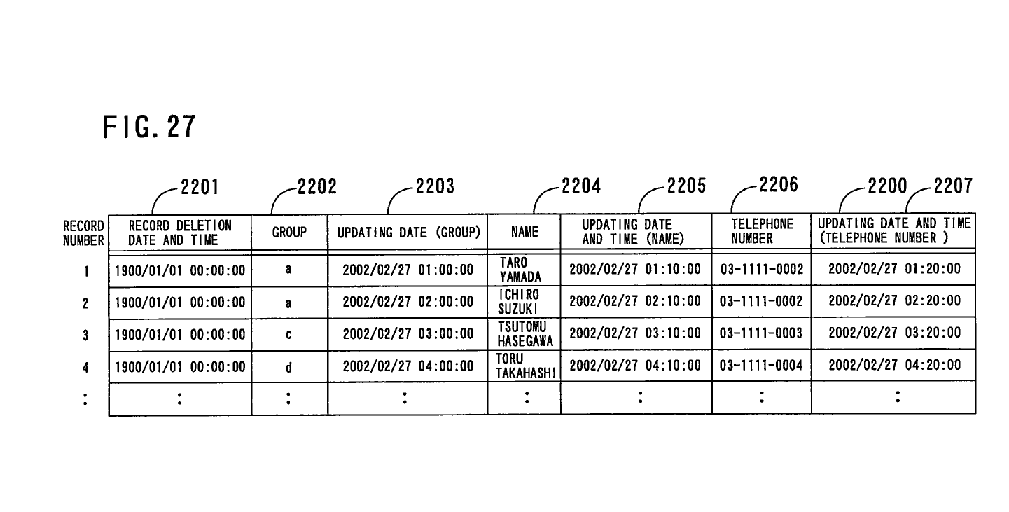

FIG. 27 shows an example of the telephone directory table of the information apparatus A which can be used suitably where the information apparatus are divided into groups in such a manner as described above to effect data management. Referring to FIG. 27, each record of the telephone directory table 2200 shown includes a group 2202 and an updating date and time (group) 2203 of the group 2202 in addition to a record deletion date and time 2201, a name 2204, an updating date and time (name) 2205, a telephone number 2206 and an updating date and time (telephone number) 2207. The records of the record numbers 1 and 2 indicate that the group=a. Thus, it can be recognized that the records mentioned share data among the information apparatus which belong to the group a (actually only the information apparatus A), that is, the records do not share the data with any other information apparatus. The record of the record number 3 indicates that the group=c. From FIG. 22, it can be seen that the information apparatus A, information apparatus B, information apparatus C, information apparatus D, information apparatus K, information apparatus L, information apparatus M, information apparatus N, information apparatus O, information apparatus P and information apparatus Q belong to the group c, and therefore, it can be recognized that the record of the record number 3 indicates that the data is shared by the information apparatus just mentioned. From the scope of group management, a data synchronization process should be performed only those information apparatus among which data is shared but need not be performed with any other information apparatus. Similarly, since the record of the record number 4 indicates that the group=3, it can be recognized that the data is shared by the information apparatus A, information apparatus B, information apparatus C, information apparatus D, information apparatus E, information apparatus F, information apparatus G, information apparatus P and information apparatus Q which belong to the group d.

It is to be noted that, where a data synchronization process is performed among a plurality of information processing apparatus as seen from FIG. 18 or 22, it is possible to shorten the time required for a data synchronization process by indirectly performing data synchronization through hearsay. It is to be noted that a synchronization process of data between the information apparatus X and the information apparatus Y is defined as “synchronize(X, Y)” or “synchronize(Y, X)”. An order in which a synchronization process among a plurality of information apparatus is performed is indicated by an arrow mark. In particular, if synchronize(R, S) is performed after synchronize(P, Q), then this is represented as “synchronize(P, Q) “synchronize(R, S)”.

A data synchronization process among the three information apparatus A, B and C is described as an example. If data synchronization is performed in the order of synchronize(A, B) “synchronize(B, C), then at a point of time when the synchronize(A, B) is performed, the data of the information apparatus A is reflected on the information apparatus B, and then at a point of time when the synchronize(B, C) is performed, the data of the information apparatus B is reflected on the information apparatus C. Accordingly, even if the synchronize(A, C) is not performed, part of the data of the information apparatus A can be reflected on the information apparatus C. Here, the reason whey part of the data of the information apparatus A is reflected on the information apparatus C is that, if the synchronize(A, C) is performed, then all of data of the group or groups to which the information apparatus A and the information apparatus C belong are reflected on the information apparatus C, but when the synchronize(A, B) “synchronize(B, C) is performed, only data of the group or groups to which all of the information apparatus A, information apparatus B and information apparatus C belong are reflected on the information apparatus C. It is to be noted that the data synchronization through hearsay may include more than two stages of hearsay like, for example, synchronize(A, B) “synchronize(B, C) “synchronize (C, D).

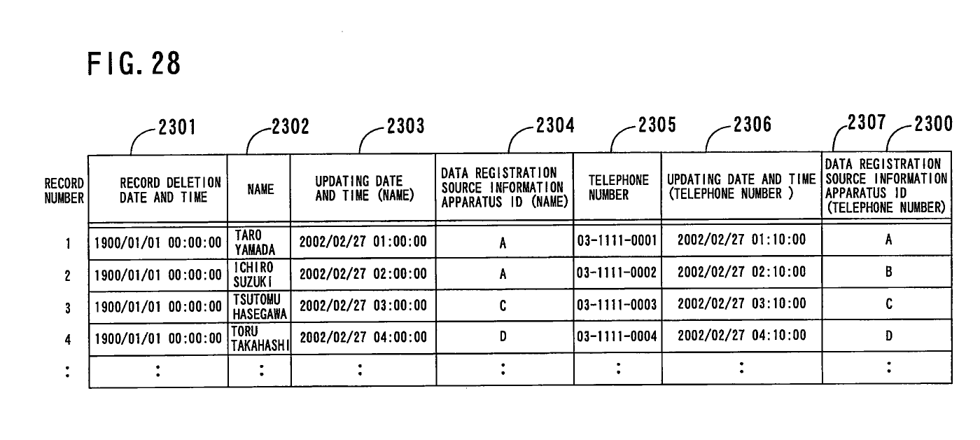

Referring to the telephone directory table shown in FIG. 28, the telephone directory table 2300 includes items of a record deletion date and time 2301, a name 2302, an updating date and time (name) 2303, a data registration source information apparatus ID (name) 2304, a telephone number 2305, a updating date and time (telephone number) 2306, and a data registration source information apparatus ID (telephone number) 2307. The data registration source information apparatus ID (name) 2304 indicates a source of data of the name 2302 including data synchronization through hearsay. Similarly, the data registration source information apparatus ID (telephone number) 2307 indicates a source of the telephone number 2305.

In order to establish data synchronism, data exchange is performed between two information apparatus, and in order to reduce the time required for a data synchronization process, data which is possessed already by the opposite information apparatus should be restrained from transmission. Where a source of each data is indicated as seen in FIG. 28, if the source of data is the opposite information apparatus, then the time required for a data synchronization process can be reduced by restraining the data from transmission.

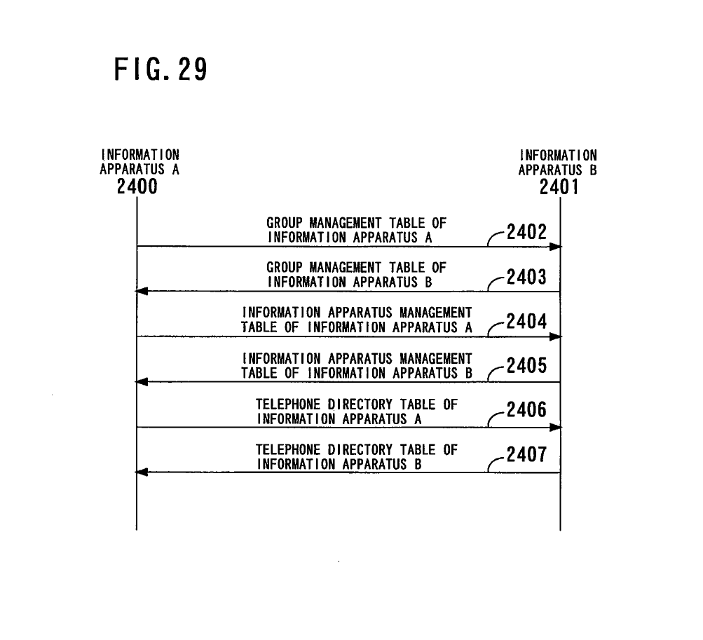

FIG. 29 illustrates an example of a sequence of operations where a data synchronization process is performed between the information apparatus A and the information apparatus B. Since the groups of the information apparatus may have been changed after data synchronism was performed last, the information apparatus A and the information apparatus B first exchange their group management tables therebetween. Then, since the address or the like of each information apparatus may have been changed, the information apparatus A and the information apparatus B exchange their information apparatus management tables therebetween and then exchange the contents of the telephone directory tables therebetween to perform data synchronization. In particular, the information apparatus A (2400) first sends the group management table of the information apparatus A itself to the information apparatus B (2401) at step 2402, and the information apparatus B sends the group management table of the information apparatus B itself to the information apparatus A at step 2403. Then, the information apparatus A and the information apparatus B exchange the information apparatus management tables of the information apparatus A and the information apparatus B therebetween similarly at steps 2404 and 2405, respectively. Finally, the information apparatus A and the information apparatus B exchange the telephone directory tables of the information apparatus A and the information apparatus B therebetween similarly at steps 2406 and 2407, respectively. While it is illustrated that the group management tables, information apparatus management tables and telephone directory tables are exchanged separately, the information of them may be exchanged collectively. Particularly where such data exchange is performed by an e-mail or the like, the number of mails can be suppressed effectively.

It is to be noted that, also where data synchronization is performed among three or more information apparatus, since the synchronization operation itself is performed individually between two information apparatus, the sequence described above is applied.

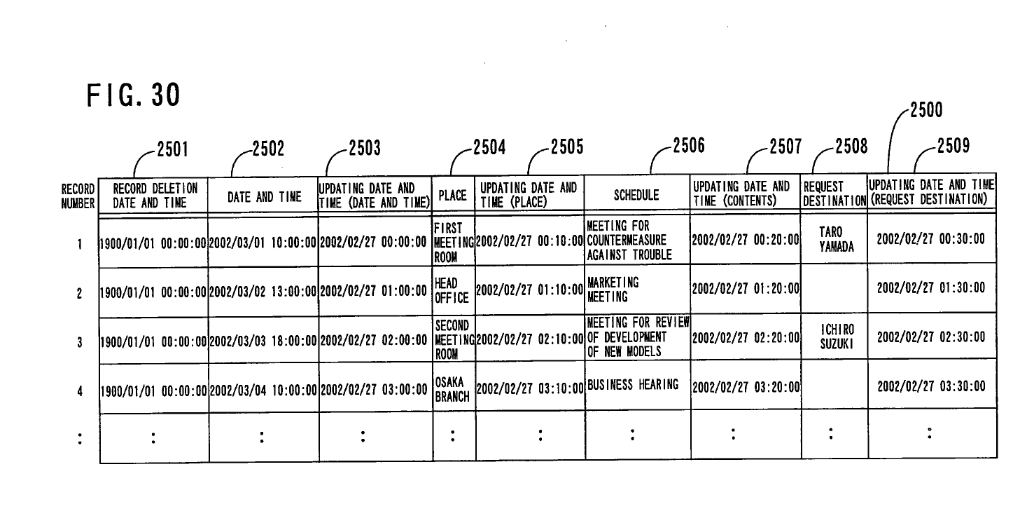

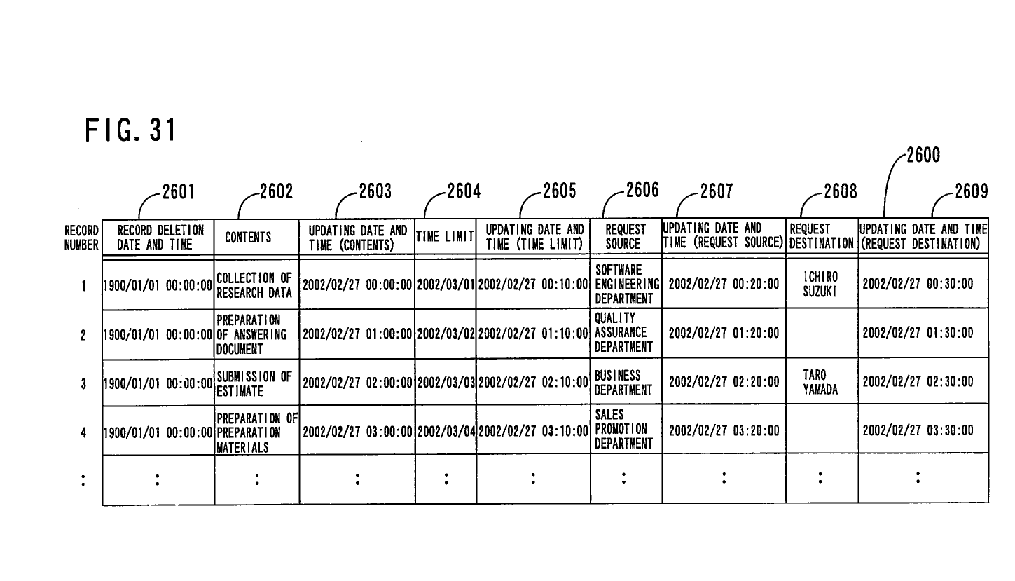

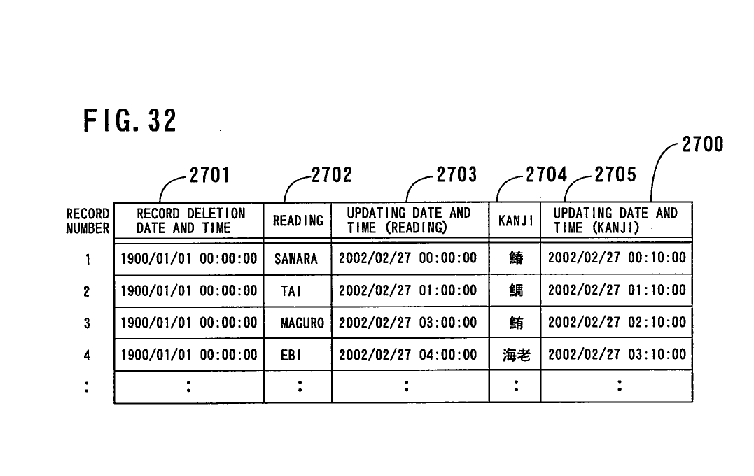

It is to be noted that, when data synchronization is to be performed, it is discriminated what should be used to determine an object record for which a data synchronism process is to be performed, that is, which one of records of the information apparatus A and which one of records of the information apparatus B should be used as an object of a synchronization process, that is, the same cell. Taking the telephone directory table as an example, an object record for a synchronization process can be determined using the “name” as a key. This key differs depending upon the contents of the data table. A “timetable table” shown in FIG. 30, a “ToDo table” shown in FIG. 31, a “dictionary table” shown in FIG. 32 and so forth are available as data tables other than the telephone directory table. Each record of the timetable table 2500 shown in FIG. 30 includes a record deletion date and time 2501, a date and time 2502, an updating date and time (date and time) 2503, a place 2504, an updating date and time (place) 2505, a schedule 2506, an updating date and time (contents) 2507, a request destination 2508 and an updating date and time (request destination) 2509. Each record of the ToDo table 2600 shown in FIG. 31 includes a record deletion date and time 2601, a contents data 2602, an updating date and time (contents data) 2603, a time limit 2604, an updating date and time (time limit) 2605, a request source 2606, an updating date and time (request source) 2607, a request destination 2608 and an updating date and time (request destination) 2609. Each record of the dictionary table 2700 shown in FIG. 32 includes a record deletion date and time 2701, a reading data 2702, an updating date and time (reading data) 2703, a kanji 2704 and an updating date and time (kanji) 2705. The “date and time” 2502 in the timetable table 2500, the “contents data” 2602 and/or the “time limit” 2604 in the ToDo table 2600 and the “kanji” 2704 in the dictionary table 2700 can be used as a key to perform a data synchronization process similarly as with the telephone directory table.

It is to be noted that the following method may be used as a countermeasure where the contents of a key are same. Taking the telephone directory table as an example, it may be a countermeasure to set the telephone directory table such that registration of the same combination of a first name and a last name may be inhibited. In other words, such a countermeasure as to annex a suffix or the like to prevent registration of data of the same combination of a first name and a last name. It is to be noted the field for storing the suffix may be set separately from the field for the name.

If the name is altered, then since this changes the key of the record, if the data is updated as it is, then this disables discrimination of the same cell upon data synchronization. Accordingly, an alteration process of a name is performed in such a form that deletion date and time is set to the pertaining record prior to the alteration of the name and data after the alteration of the name is added as a new record to the table. In other words, in place of updating of the record, deletion of the record and addition of another record are performed. More particularly, if data synchronization between the information apparatus A and B is performed after an alteration to a name is performed on the information apparatus A, then the deletion date and time is reflected on the record of the information apparatus B prior to the alteration of the name and a record after the alteration to the name is added newly thereby to achieve correct data synchronization.

Subsequently, a method of rubbing out a deleted record from a data table is described. In the foregoing description, when a record is deleted, the deletion date and time is set to the pertaining record to represent that the data is recorded. Accordingly, every time deletion is performed, a record in which the deletion date and time is set (deletion date ? 1900/01/01 00:00:00) is cumulatively stored. Since this increases the table size endlessly, garbage collection of deleted records is performed.

Garbage collection of deleted records is performed after the record in question is deleted in all information apparatus of the group to which the information apparatus in question belongs by data synchronization. More particularly, garbage collection is performed at a point of time when the condition that, in the information apparatus management tables shown in FIGS. 25 and 26, the last synchronization date and time with all of the other information apparatus of the group to which the pertaining information apparatus belongs is newer than the deletion date and time of the pertaining record is satisfied. Where the pertaining information apparatus performs the data synchronization process directly with all of the other information apparatus of the group to which it belongs, since the last synchronization date and time is updated at the point of time, the condition specified as above is satisfied.

It is to be noted that, even where a date synchronization process through hearsay is performed, if also a synchronization process of the information apparatus management table is performed in such a manner as illustrated in FIG. 29, then it can be discriminated with which opposite information apparatus the data of the information apparatus itself has been synchronized. From this, it can be discriminated whether or not the pertaining record is deleted in all of the other information apparatus of the group to which the pertaining information apparatus belongs through the data synchronization. Accordingly, garbage collection is performed at a point of time at which the record is deleted in all of the information apparatus through the data synchronization.

It is to be noted that the data synchronization process may be started under the will of the user of the pertaining information apparatus designating the opposite information apparatus with which data exchange should be performed or may be performed periodically in accordance with a schedule set in advance for execution of data processing. The former method is effective in such a case that the user tries to update the data of the other information apparatus when the user updates the data. On the other hand, the latter method is suitable where information apparatus performs radio communication or the like for data exchange. In particular, only if the information apparatus are placed within a radio wave range, data synchronization can be performed automatically and periodically. In the latter case, data synchronization is performed even if the user is not conscious.

While preferred embodiments of the present invention have been described using specific terms, such description is for illustrative purposes only, and it is to be understood that changes and variations may be made without departing from the spirit or scope of the following claims.

1. A data synchronization method between a plurality of information apparatus for performing synchronization of data stored in said information apparatus, a record which forms data retained by each of said information apparatus including one or more data items, comprising:
a step, executed by each of said information apparatus when self data thereof is updated, of fetching time stamp information which indicates updating date and time for each of the data items;
a step, executed by a first one of said information apparatus, of transmitting the self data thereof including the time stamp information of each of the data items to a second one of said information apparatus which is a destination of data synchronization; and
a step, executed by the second information apparatus upon reception of the data transmitted from the first information apparatus, of comparing, regarding a data item which is an object of updating, the time stamp information of the self data thereof and the time stamp information transmitted from the first information apparatus with each other and fetching the newest time stamp information to update the self data thereof.

2. A data synchronization method between a plurality of information apparatus as claimed in claim 1, further comprising:
a step, executed by the second information apparatus, of transmitting the data including the updated time stamp information of each of the data items to the first information apparatus; and
a step, executed by the first information apparatus, of comparing, regarding the data item which is an object of updating, the time stamp information of the self data thereof and the time stamp information transmitted from the second information apparatus with each other and fetching the newest time stamp information to update the self data thereof.

3. A data synchronization method between a plurality of information apparatus as claimed in claim 1, wherein the data is formed from a plurality of data tables which are related to each other.

4. A data synchronization method between a plurality of information apparatus as claimed in claim 1, wherein the record which forms the data includes data which indicates an attribute of the record and a data synchronization process regarding the record is performed in accordance with the attribute.

5. A data synchronization method between a plurality of information apparatus as claimed in claim 1, wherein said information apparatus are divided into arbitrary groups each of which defines a range within which data exchange is to be performed, and each of said information apparatus includes, regarding all information apparatus which belong to a group to which the information apparatus itself belongs, group management data for managing a relationship regarding to which group each of said information apparatus belongs and selects, based on the group management data, an opposite information apparatus with which the information apparatus itself is to perform the synchronization process.

6. A data synchronization method between a plurality of information apparatus as claimed in claim 5, further comprising:
a step, executed by each of said information apparatus, of fetching time stamp information which indicates updating date and time of each record of the group management data;
a step, executed by the first information apparatus, of transmitting the group management data including the time stamp information to the second information apparatus which is a destination of data synchronization; and
a step, executed by the second information apparatus upon reception of the data transmission from the first information apparatus, of comparing the time stamp information of the self group management data thereof and the time stamp information of the group management data transmitted from the first information apparatus with each other and fetching the newest group management data to update the self group management data thereof.

7. A data synchronization method between a plurality of information apparatus as claimed in claim 6, further comprising:
a step, executed by the second information apparatus upon reception of the transmission of the group management data, of transmitting the group management data thereof including the time stamp information updated thereby to the first information apparatus; and
a step, executed by the first information apparatus upon reception of the data transmission from the second information apparatus, of comparing, regarding the group management data, the self time stamp information thereof and the time stamp information transmitted from the second information apparatus with each other and fetching the newest group management data information to update the self group management data thereof.

8. A data synchronization method between a plurality of information apparatus as claimed in claim 1, wherein each of said information apparatus includes information apparatus management data for managing access information to an opposite information apparatus with which the information apparatus is to perform the data synchronization, and accesses, based on the information apparatus management data, the opposite information apparatus with which the information apparatus is to perform the synchronization process.

9. A data synchronization method between a plurality of information apparatus as claimed in claim 8, wherein a record which forms the information apparatus management data includes time stamp information which indicates updating date and time of the record, and further comprising:
a step, executed by the first information apparatus, of transmitting the information apparatus management data including the time stamp information to the second information apparatus which is the data synchronization destination; and
a step, executed by the second information apparatus upon reception the data transmission from the first information apparatus, of comparing the time stamp information of the self information apparatus management data thereof and the time stamp information of the information apparatus management data transmitted from the first information apparatus with each other and fetching the newest information apparatus management data to update the self group management data thereof.

10. A data synchronization method between a plurality of information apparatus as claimed in claim 9, further comprising:
a step, executed by the second information apparatus upon reception of the transmission of the information apparatus management data, of transmitting the information management data thereof including the time stamp information updated thereby to the first information apparatus; and
a step, executed by the first information apparatus upon reception of the data transmission, of comparing, regarding the information apparatus management data, the self time stamp information thereof and the time stamp information transmitted from the second information apparatus with each other and fetching the newest information apparatus management data to update the self information apparatus management data thereof.

11. A data synchronization method between a plurality of information apparatus as claimed in claim 9, wherein each of said information apparatus possesses data which indicates last synchronization date and time of each of said information apparatus which serves as a source of data transmission and performs data updating only when the time stamp information is newer than the last synchronization date and time of the information apparatus which is the source of the data transmission.

12. A data synchronization method between a plurality of information apparatus as claimed in claim 1, wherein the data possessed by each of said information apparatus includes information which indicates an information apparatus of an origin of data for each record or each data item and does not perform the synchronization process regarding the record or data item when the information apparatus of the origin of the data is same as the information apparatus which is a destination of data synchronization.

13. A data synchronization method between a plurality of information apparatus as claimed in claim 1, wherein, in all of said information apparatus, or in all of those of said information apparatus which belong to a group in which the data synchronization process is performed, garbage collection is performed after data synchronization is performed for information that a record of a processing object is deleted.

14. A synchronization method between a plurality of information apparatus as claimed in claim 1, wherein the data synchronization process is performed automatically in accordance with a predetermined time schedule.

15. A synchronization method between a plurality of information apparatus as claimed in claim 1, wherein each of said information apparatus is selected from among apparatus including a portable telephone set, a personal computer, a PDA, a PHS terminal, a subscriber telephone set or a slave machine of a subscriber telephone set.

16. A synchronization method between a plurality of information apparatus as claimed in claim 1, wherein, as a communication method between said information apparatus, a portable telephone network, a PHS telephone network, a cradle, the Internet, a subscriber telephone network, communication between a master machine and a slave machine of a subscriber telephone set, communication between slave machines of a subscriber telephone set or radio communication is used.

17. A data synchronization method between a plurality of information apparatus for performing synchronization of data stored in said information apparatus, a record which forms data retained by each of said information apparatus including a first data item which indicates deletion information of the record and one or more second data items other than the first data item, comprising:
a step, executed by each of said information apparatus when self data is updated, of fetching first time stamp information regarding the first data item and fetching, regarding each of the second data items, second time stamp information which indicates updating date and time for each of the second data items;
a step, executed by a first one of said information apparatus, of transmitting the self data thereof including the first and second time stamp information to a second one of said information apparatus; and
a step, executed by the second information apparatus upon reception of the data transmitted from the first information apparatus, of performing comparison, regarding the first and second data items included in a record of an updating object, between deletion information of the records, between both of the first time stamp information, between the first time stamp information and the second time stamp information, or between both of the second time stamp information and fetching the newest data to update the self data thereof.

18. A data synchronization method between a plurality of information apparatus as claimed in claim 4, further comprising:
a step, executed by the second information apparatus upon reception of the data transmission from the first information apparatus, of transmitting the updated data to the first information apparatus; and
a step, executed by the first information apparatus upon reception of the data transmission from the second information apparatus, of performing comparison, regarding the first and second data items included in the record of the updating object, between both of the deletion information of the records, between both of the first time stamp information, between the first time stamp information and the second time stamp information, or between both of the second time stamp information with each other and fetching the newest data to update the self data thereof.

19. A data synchronization method between a plurality of information apparatus as claimed in claim 17, wherein the data is formed from a plurality of data tables which are related to each other.

20. A data synchronization method between a plurality of information apparatus as claimed in claim 17, wherein the record which forms the data includes data which indicates an attribute of the record and a data synchronization process regarding the record is performed in accordance with the attribute.

21. A data synchronization method between a plurality of information apparatus as claimed in claim 17, wherein said information apparatus are divided into arbitrary groups each of which defines a range within which data exchange is to be performed, and each of said information apparatus includes, regarding all information apparatus which belong to a group to which the information apparatus itself belongs, group management data for managing a relationship regarding to which group each of said information apparatus belongs and selects, based on the group management data, an opposite information apparatus with which the information apparatus itself is to perform the synchronization process.

22. A data synchronization method between a plurality of information apparatus as claimed in claim 21, further comprising:
a step, executed by each of said information apparatus, of fetching time stamp information which indicates updating date and time of each record of the group management data;
a step, executed by the first information apparatus, of transmitting the group management data including the time stamp information to the second information apparatus which is a destination of data synchronization; and
a step, executed by the second information apparatus upon reception of the data transmission from the first information apparatus, of comparing the time stamp information of the self group management data thereof and the time stamp information of the group management data transmitted from the first information apparatus with each other and fetching the newest group management data to update the self group management data thereof.

23. A data synchronization method between a plurality of information apparatus as claimed in claim 22, further comprising:
a step, executed by the second information apparatus upon reception of the transmission of the group management data, of transmitting the group management data thereof including the time stamp information updated thereby to the first information apparatus; and
a step, executed by the first information apparatus upon reception of the data transmission from the second information apparatus, of comparing, regarding the group management data, the self time stamp information thereof and the time stamp information transmitted from the second information apparatus with each other and fetching the newest group management data information to update the self group management data thereof.

24. A data synchronization method between a plurality of information apparatus as claimed in claim 17, wherein each of said information apparatus includes information apparatus management data for managing access information to an opposite information apparatus with which the information apparatus is to perform the data synchronization, and accesses, based on the information apparatus management data, the opposite information apparatus with which the information apparatus is to perform the synchronization process.

25. A data synchronization method between a plurality of information apparatus as claimed in claim 24, wherein a record which forms the information apparatus management data includes time stamp information which indicates updating date and time of the record, and further comprising:
a step, executed by the first information apparatus, of transmitting the information apparatus management data including the time stamp information to the second information apparatus which is the data synchronization destination; and
a step, executed by the second information apparatus upon reception the data transmission from the first information apparatus, of comparing the time stamp information of the self information apparatus management data thereof and the time stamp information of the information apparatus management data transmitted from the first information apparatus with each other and fetching the newest information apparatus management data to update the self group management data thereof.

26. A data synchronization method between a plurality of information apparatus as claimed in claim 25, further comprising:
a step, executed by the second information apparatus upon reception of the transmission of the information apparatus management data, of transmitting the information management data thereof including the time stamp information updated thereby to the first information apparatus; and
a step, executed by the first information apparatus upon reception of the data transmission, of comparing, regarding the information apparatus management data, the self time stamp information thereof and the time stamp information transmitted from the second information apparatus with each other and fetching the newest information apparatus management data to update the self information apparatus management data thereof.

27. A data synchronization method between a plurality of information apparatus as claimed in claim 25, wherein each of said information apparatus possesses data which indicates last synchronization date and time of each of said information apparatus which serves as a source of data transmission and performs data updating only when the time stamp information is newer than the last synchronization date and time of the information apparatus which is the source of the data transmission.

28. A data synchronization method between a plurality of information apparatus as claimed in claim 17, wherein the data possessed by each of said information apparatus includes information which indicates an information apparatus of an origin of data for each record or each data item and does not perform the synchronization process regarding the record or data item when the information apparatus of the origin of the data is same as the information apparatus which is a destination of data synchronization.

29. A data synchronization method between a plurality of information apparatus as claimed in claim 17, wherein, in all of said information apparatus, or in all of those of said information apparatus which belong to a group in which the data synchronization process is performed, garbage collection is performed after data synchronization is performed for information that a record of a processing object is deleted.

30. A synchronization method between a plurality of information apparatus as claimed in claim 17, wherein the data synchronization process is performed automatically in accordance with a predetermined time schedule.

31. A synchronization method between a plurality of information apparatus as claimed in claim 17, wherein each of said information apparatus is selected from among apparatus including a portable telephone set, a personal computer, a PDA, a PHS terminal, a subscriber telephone set or a slave machine of a subscriber telephone set.

32. A synchronization method between a plurality of information apparatus as claimed in claim 17, wherein, as a communication method between said information apparatus, a portable telephone network, a PHS telephone network, a cradle, the Internet, a subscriber telephone network, communication between a master machine and a slave machine of a subscriber telephone set, communication between slave machines of a subscriber telephone set or radio communication is used.

33. An information processing apparatus for use with an information processing system for performing data exchange between a plurality of information apparatus, comprising:
data storage means for storing data of the self information apparatus;
data reception means for receiving data from an opposite information apparatus;
data comparison means for comparing the data stored in said data storage means and the data received by said data reception means;
data updating means for updating the data of the self information apparatus based on a result of the data comparison by said data comparison means;
time management means for managing data updating time of the day in said data updating means; and
data transmission means for transmitting the data possessed by the self information apparatus to the opposite information apparatus.

34. An information processing apparatus for use with an information processing system for performing data exchange between a plurality of information apparatus, said plurality of information apparatus being divided into groups of apparatus within which the apparatus perform data exchange with each other, each of said information apparatus possessing group management data for managing a group belonging destination regarding all of those of said information apparatus which belong to a group to which the self information apparatus belongs, comprising:
data storage means for storing data of the self information apparatus;
data reception means for receiving data from an opposite information apparatus;
data comparison means for comparing the data stored in said data storage means and the data received by said data reception means with each other;
data updating means for updating the data of the self information apparatus based on a result of the data comparison by said data comparison means;
time management means for managing data updating time of the day in said data updating means;
data transmission means for transmitting the data possessed by the self information apparatus to the opposite information apparatus;
group management data storage means for storing group management data of the self information apparatus;
group management data comparison means for comparing the data stored in said group management data storage means and group management data of the opposite information apparatus transmitted through said data reception means with each other;
group management data updating means for updating the group management data of the self information apparatus based on a result of the comparison by said group management data comparison means; and
time management means for managing data updating time of the day in said group management data updating means.

35. (canceled)

36. (canceled)

37. (canceled)

38. (canceled)

39. (canceled)

40. (canceled)

41. (canceled)
